(19) United States
(12) Patent Application Publication
(10) Pub. No.: US 2010/0285081 A1
(43) Pub. Date: Nov. 11, 2010

(54) Bactericidal Nanofibers, and Methods of Use Thereof

(75) Inventors: Liang Chen, Cambridge, MA (US); Lev E. Bromberg, Swampscott, MA (US); Trevor Alan Hatton, Sudbury, MA (US); Gregory C. Rutledge, Newton, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: MASSACHUSETTS INSTITUTE OF TECHNOLOGY, CAMBRIDGE, MA (US)

(21) Appl. No.: 12/741,478

(22) PCT Filed: Nov. 12, 2008
(86) PCT No.: PCT/US08/83208

§ 371 Date: Jul. 23, 2010

Related U.S. Application Data
(60) Provisional application No. 60/987,220, filed on Nov. 12, 2007.

(51) Int. Cl. A01N 25/00; A01N 47/44; A01P 1/00

(52) U.S. Cl. 424/405; 514/635

(57) ABSTRACT

One aspect of the invention relates to an antimicrobial fiber formed from an electroprocessed blend of at least one polymer, at least one antimicrobial agent, and at least one crosslinker. Another aspect of the invention relates to an antimicrobial fiber formed from an electroprocessed blend of at least one polymer and at least one crosslinker, which is then coated with an antimicrobial compound or antimicrobial polymer.

### RELATED APPLICATIONS

This application claims the benefit of priority to U.S. Provisional Patent Application Ser. No. 60/987,220, filed Nov. 12, 2007; the entirety of which is incorporated by reference.

### BACKGROUND

Adhesion to and proliferation of bacteria on the surfaces of materials can induce severe health and environmental hazards [Costerton J W, Stewart P S, Greenberg E P. Science 1999; 284:1318]. Hence, there is a great demand for bactericidal, antiseptic, and bacteriostatic materials that can prevent attachment, proliferation and survival of microbes on the material surface. A broad range of antibacterial agents, such as silver, quaternary ammonium groups, hydantoin compounds, and tetracycline antibiotics, have been incorporated in or attached onto the surfaces of various materials, such as textiles and medical devices [Lin J, Qiu S, Lewis K, Klibanov A M. Biotechnol Bioeng 2003; 83:168; Sun Y, Sun G. J Appl Polym Sci 2003; 88:1032; Danese P N. Chem Biol 2002; 9:873; Ruggeri V, Francolini I, Donelli G, Piozzi A. J Biomed Mater Res A 2007; 81A:287; and Morris C E, Welch C M. Textile Res J 1983; 53:143].

For example, solid surfaces that have been modified by covalent attachment of antimicrobial agents include those described in Engel et al. U.S. Pat. No. 7,241,453 (hereby incorporated by reference); Morris C E, Welch C M. Textile Res. J. 1983, 53, 143; and Tiller, et al. U.S. Pat. No, 7,151,139 (hereby incorporated by reference). However, these methods are only applicable to articles already manufactured; they are not applicable to the treatment of materials that are subsequently processed into fibers, which limits the applicability of the methods of manufacturing to materials that are activated and modified only after processing, which can unfavorably change the surface morphology and functionality of the processed articles.

Electrospinning is a simple and versatile method for fiber preparation, which employs electrostatic forces that stretch a polymer jet to generate continuous fibers with diameters ranging from micrometers down to several nanometers [Dzenis Y. Science 2004; 304:1917; Li D, Xia Y. Adv Mater 2004; 16:1151; Fridrikh S V, Yu J H, Brenner M P, Rutledge G C. Phys Rev Lett 2003; 90:144502; Hohman M M, Shin M, Rutledge G, Brenner M P. Phys Fluids 2001; 13:2201; Hohman M M, Shin M, Rutledge G, Brenner M P. Phys Fluids 2001; 13:2221; Reneker D H, Yarin A L, Fong H, Koombhongse S. J Appl Phys 2000; 87:453; Yarin A L, Koombhongse S, Reneker D H. J Appl Phys 2001; 89:3018; and Yarin A L, Koombhongse S, Reneker D H. J Appl Phys 2001; 90:4836]. Electrospun fiber meshes possess remarkable features, such as small fiber diameter, high specific surface area, high porosity, and low fabric weight. These unique properties have triggered evaluation of a broad range of potential applications, including nanocomposites [Li D, Wang Y, Xia Y. Nano Lett 2003; 3:1167; and Wang M, Hsieh A J, Rutledge G C. Polymer 2005; 46:3407], scaffolds for tissue engineering [Jin H-J, Chen J, Karageorgious V, Altman G H, Kaplan D L. Biomaterials 2004; 25:1039], sensors [Wang X, Kim Y, Drew C, Ku B, Kumar J, Samuelson L A. Nano Lett 2004; 4:331], protective clothing and filtration membranes [Gibson P, Schreuder-Gibson H, Rivin D. Colloids Surf A 2001; 187-188:469; and Chen L, Bromberg L, Hatton T A, Rutledge G C. Polymer 2007; 48:4675], magneto-responsive fibers [Wang M, Singh H, Hatton T A, Rutledge G C. Polymer 2004; 45:5505], and superhydrophobic membranes [Acatay K, Simsek E, Ow-Yang C, Menceloglu Y. Angew Chem, Int Ed Eng 2004; 43:5210; and Ma M L, Hill R M, Lowery J L, Fridrikh S V, Rutledge G C. Langmuir 2005; 21:5549].

### SUMMARY

One aspect of the invention relates to novel antimicrobial surfaces of fibers. Another aspect of the invention relates to bactericidal fiber meshes produced by electrospinning polymer blends containing a polymer, a biocide, and an organic or aqueous solvent. In certain embodiments, the fibers are less than 10 microns in diameter. Yet another aspect of the invention relates to the methods of electrospinning to form bactericidal fibers and meshes thereof. Moreover, it is herein disclosed that any component of the solution, including an additive provided especially for microorganism killing action, may be used to induce the desired conductivity of the solution for electrospinning

In certain embodiments, the polymer comprises cellulose acetate. In certain embodiments, a high molecular weight polymer, such as poly(ethylene oxide), may be added to the polymer blend to induce electrospinnability and facilitate the formation of fibers. In certain embodiments, the fibers are cross-linked. In certain embodiments, the rheological properties of the polymer solution are such that the polymer is able to form a stable jet.

In certain embodiments, the biocide comprises chlorhexidine and/or one or more other compounds with sufficient ability to kill microorganisms. In certain embodiments, the biocide is crosslinked entirely or in part to the high molecular weight component of the fiber. In certain embodiments, the biocide and/or crosslinking agent may be introduced to the fiber solution prior to fiber formation by electrospinning, by exposure of the formed fibers to a solution containing the biocide and/or crosslinking agent, or by layer-by-layer deposition of a biocidal coating.

In certain embodiments, the inventive fibers are bactericidal through both a gradual release of unbound bactericide from the fibers and through contact with bound bactericide on the surface of the fibers.

For example, herein are disclosed dually functional antibacterial fibers generated by electrospinning a series of blends of cellulose acetate (CA) and chlorhexidine (CHX) with (a) a part of CHX bound to the CA polymer matrix by the organic titanate linker, Tyzor® TE (TTE), and (b) a significant fraction of CHX unbound but embedded within the fibers. Antibacterial CHX fibers were also produced by a post-spin treatment process to immobilize CHX on already prepared CA fibers. The resulting bactericidal electrospun CA-CHX fibers possessed significant antibacterial activity against both the gram-negative strain of Escherichia coli (E. coli) and the gram-positive strain of Staphylococcus epidermidis (S. epidermidis).

### BRIEF DESCRIPTION OF THE FIGURES

FIG. 1 depicts (a) chlorhexidine (CHX); and (b) a scheme showing the binding of amino groups of CHX to hydroxyl groups of a cellulose acetate (CA) polymer matrix via titanate links using Tyzor® TE (TTE).

FIG. 2 depicts (a) a table showing relaxation times, Deborah numbers and fiber morphology of CA-PEO solutions; and (b) a table showing solution properties of polymer blends for electrospinning.

FIG. 3 depicts (a) a table showing the extent of binding of CHX to the fibers; and (b) a table showing the results of the contact-killing test by a modified ASTM E2149-01 procedure against E. coli and S. epidermidis.

FIG. 4 depicts extensional properties of CA-PEO solutions: (a) filament diameter evolution curves; and (b) extensional viscosity vs. Hencky strain.

FIG. 5 depicts typical electrospun fiber morphologies for CA-PEO solutions: (a) 3 wt % CA, 0.3 wt % PEO (2M), De=1.9, droplets; (b) 3 wt % CA, 0.1 wt % PEO (5M), De=6.6, beads-on-string; and (c) 3 wt % CA, 0.3 wt % PEO (5M), De=18.7, uniform fibers.

FIG. 6 depicts SEM images of CA-CHX fibers: (a) as-spun fibers (fiber diameter: 950±100 nm); and (b) fibers after curing under saturated water vapor at 70° C. for four days.

FIG. 7 depicts FTIR and Raman spectra of fully washed CA-CHX fibers and nonfunctional CA-TTE fibers.

FIG. 8 depicts an XPS spectrum of fully washed CA-CHX fibers with 7.3 wt % of bound CHX.

FIG. 9 depicts photo images of agar plates after disk diffusion tests (E. coli): (a) CA-CHX fibers without water treatment; and (b) CA-CHX fibers completely washed out prior to test.

FIG. 10 depicts disk diffusion test results for CA-CHX fibers: (a) Zone of inhibition (ZoI) vs. the amount of CHX released per unit area (M) of the fibers for E. coli and S. epidermidis wherein the solid curves were obtained by translating the corresponding linear regression lines of (ZoI)² vs. ln(M) in (b) into the ZoI vs. M plots; and (b) (ZoI)² vs. ln(M) for E. coli and S. epidermidis wherein the solid lines are linear regression lines of (ZoI)² vs. ln(M).

FIG. 11 depicts SEM images of (a) as-spun nonfunctional CA-PEO fibers and (b) post-spin treated CA-PEO fibers with the attachment of CHX onto the fibers.

FIG. 12 depicts (a) modification of polyvinylamine to poly(N-vinylguanidine); (b) polyhydroxamic acid; and (c) poly(hexamethylene biguanide).

FIG. 13 depicts SEM images of (a) prefabricated PAN fiber mats and (b) PHA/PVG coated PAN fiber mats.

FIG. 14 depicts (a) a table showing the ability of PVG/PHA-coated PAN fiber mats to kill bacteria on contact; and (b) a table showing the bactericidal activity of nanofibers against S. aureus, wherein bactericidal activity is rounded to the nearest tenth place.

### DETAILED DESCRIPTION

One aspect of the invention relates to polymer materials that can be manufactured with enhanced bactericidal activity by chemically bonding a bactericidal agent to polymeric material before processing, after processing, or both before and after processing. Such materials can be used in the formation of fine fibers, such as microfibers and nanofiber materials with enhanced bactericidal activity. Such fibers are useful in a variety of applications. In one application, fiber material is used in wearable garments. In another application, filter structures can be prepared using the fibers. Certain aspects of the invention relate to textiles, fabrics, polymeric composition, fibers, filters, and methods of filtering comprising materials of the invention.

### Electroprocessing

In the present invention, electrospinning is a preferred form of electroprocessing (see, for example, U.S. Patent Application Publication No. 20060263417, hereby incorporated by reference). The term “electroprocessing” shall be defined broadly to include all methods of electrospinning, electrospraying, electroaerosoling, and electrosputtering of materials, combinations of two or more such methods, and any other method wherein materials are streamed, sprayed, sputtered or dripped across an electric field and toward a target. The electroprocessed material can be electroprocessed from one or more grounded reservoirs in the direction of a charged substrate or from charged reservoirs toward a grounded target. “Electrospinning” means a process in which fibers are formed from a solution or melt by streaming an electrically charged solution or melt through an orifice. “Electroaerosoling” means a process in which droplets are formed from a solution or melt by streaming an electrically charged polymer solution or melt through an orifice. The term electroprocessing is not limited to the specific examples set forth herein, and it includes any means of using an electrical field for depositing a material on a target.

Electrospinning is an attractive process for fabricating fibers due to the simplicity of the process and the ability to generate microscale and nanoscale features with synthetic and natural polymers [Nair L S, Bhattacharyya S, Laurencin C T. Expert Opin Biol Ther. 2004, 4:659-68]. Electrospinning uses an electrical charge to form fibers. Electrospinning shares characteristics of both the commercial electrospray technique and the commercial spinning of fibers. The standard setup for electrospinning consists of a spinneret with a metallic needle, a syringe pump, a high-voltage power supply, and a grounded collector. A polymer, sol-gel, composite solution (or melt) is loaded into the syringe and this liquid is driven to the needle tip by a syringe pump, forming a droplet at the tip. When a voltage is applied to the needle, the droplet is first stretched into a structure called the Taylor cone. If the viscosity of the material is sufficiently high, varicose breakup does not occur (if it does, droplets are electrosprayed) and an electrified liquid jet is formed. The jet is then elongated and whipped continuously by electrostatic repulsion until it is deposited on the grounded collector. Whipping due to a bending instability in the electrified jet and concomitant evaporation of solvent (and, in some cases reaction of the materials in the jet with the environment) allow this jet to be stretched to nanometer-scale diameters. The elongation by bending instability results in the fabrication of uniform fibers with nanometer-scale diameters.

To date, a broad range of polymers has be processed by electrospinning, including polyamides, polylactides, cellulose derivatives, water soluble polymers, such as polyethyleneoxide, as well as polymer blends or polymers containing solid nanoparticles or functional small molecules [Huang Z M, Zhang Y Z, Kotaki M, Ramakrishna S. Composites Science and Technology. 2003, 63:2223-2253]. More recently, the electrospinning process has been employed for producing fibrous scaffolds for tissue engineering from both natural and synthetic polymers [Buchko C J, Chen L C, Shen Y, and Martin D C. Polymer 1999, 40: 7397-7407]. Bowland et al. fabricated a three-layered vascular construct by electrospinning collagen and elastin [Boland E D, Matthews J A, Pawlowski K J, Simpson D G, Wnek G E, Bowlin G L. Front Biosci. 2004, 9:1422-1432]. To date, electrospun fibrous scaffolds have been fabricated with numerous synthetic biodegradable polymers, such as poly(epsilon-caprolactone) (PCL), poly(lactic acid) (PLA), poly(glycolic acid) (PGA), and the copolymers poly(lactide-co-glycolide) (PLGA) [Li W J, Laurencin C T, Caterson E J, Tuan R S, Ko F K. J Biomed Mater Res. 2002, 60(4):613-621; Kim K, Yu M, Zong X, Chiu J, Fang D, Seo Y S, Hsiao B S, Chu B, Hadjiargyrou M. Biomaterials 2003, 24:4977-4985; Bhattarai S R, Bhattarai N, Yi H K, Hwang P H, Cha D I, Kim H Y. Biomaterials 2004, 25: 2595-2602; and Katti D S, Robinson K W, Ko F K, Laurencin C T. J Biomed Mater Res. 2004, 70B(2):286-296]. Electrospun scaffolds have been proposed for use in the engineering of bone tissue [Li W J, Danielson K G, Alexander P G, Tuan R S. J Biomed Mater Res. 2003, 67A(4):1105-1114; Yoshimoto H, Shin Y M, Terai H, Vacanti J P. Biomaterials 2003, 24(12):2077-2082; and Shin M, Yoshimoto H, Vacanti J P. Tissue Eng. 2004, 10(1-2):3341] and cardiac grafts [Shin M, Ishii O, Sueda T, Vacanti J P. Biomaterials. 2004, 25(17):3717-3723.]. Similarly, poly(L-lactide-co-epsilon-caprolactone) [P(LLA-CL)] has been electrospun into nanofibrous scaffolds for engineering blood vessel substitutes [Mo X M, Xu C Y, Kotaki M, Ramakrishna S. Biomaterials. 2004, 25(10):1883-1890; and Xu C Y, Inai R, Kotaki M, Ramakrishna S. Biomaterials. 2004, 25(5):877-886].

Any solvent can be used that allows delivery of the material or substance to the orifice, tip of a syringe, or other site from which the material will be electroprocessed. The solvent may be used for dissolving or suspending the material or the substance to be electroprocessed. Solvents useful for dissolving or suspending a material or a substance depend on the material or substance. Electrospinning techniques often require more specific solvent conditions. For example, certain monomers can be electrodeposited as a solution or suspension in water, 2,2,2-trifluoroethanol, 1,1,1,3,3,3-hexafluoro-2-propanol (also known as hexafluoroisopropanol or HFIP), isopropanol or other lower order alcohols, especially halogenated alcohols, may be used. Other solvents that may be used or combined with other solvents in electroprocessing natural matrix materials include acetamide, N-methylformamide, N,N-dimethylformamide (DMF), dimethylsulfoxide (DMSO), dimethylacetamide, N-methyl pyrrolidone (NMP), acetic acid, trifluoroacetic acid, ethyl acetate, acetonitrile, trifluoroacetic anhydride, 1,1,1-trifluoroacetone, maleic acid, hexafluoroacetone.

### Electroprocessed Fibers

The invention relates in part to polymeric compositions with improved properties that can be used in a variety of applications including, for example, the formation of bactericidal fibers, fine fibers, microfibers, nanofibers, fiber webs, fibrous mats, as well as permeable structures, such as membranes, coatings or films.

As mentioned above, in certain embodiments, the fibers of the invention are electroprocessed. For example, the fibers of the invention may be electrospun as described above. Fibers spun electrostatically can have a small diameter. These diameters may be as small as about 0.3 nanometers and are more typically between about 10 nanometers and about 25 microns. In certain embodiments, the fiber diameters are on the order of about 100 nanometers to about 10 microns. In certain embodiments, the fiber diameters are on the order of about 100 nanometers to about 2 microns. Such small diameters provide a high surface-area to mass ratio. Within the present invention, a fiber may be of any length. The term fiber should also be understood to include particles that are drop-shaped, flat, or that otherwise vary from a cylindrical shape.

### Polymers

Polymer materials that can be used in the compositions of the invention include both addition polymer and condensation polymer materials, such as polyolefin, polyacetal, polyamide, polyacrylonitrile, polyester, cellulose ether and ester, polyalkylene sulfide, polyarylene oxide, polysulfone, modified polysulfone polymers and mixtures thereof. Preferred materials that fall within these generic classes include polyethylene, polyacrylonitrile, polypropylene, poly(vinylchloride), polymethylmethacrylate (and other acrylic resins), polystyrene, and copolymers thereof (including ABA type block copolymers), poly(vinylidene fluoride), poly(vinylidene chloride), polyvinylalcohol in various degrees of hydrolysis (87% to 99.5%) in crosslinked and non-crosslinked forms.

One class of polyamide condensation polymers are nylon materials. The term “nylon” is a generic name for all long chain synthetic polyamides. Typically, nylon nomenclature includes a series of numbers, such as in nylon-6,6 which indicates that the starting materials are a C₆ diamine and a C₆ diacid. Another nylon can be made by the polycondensation of epsilon caprolactam in the presence of a small amount of water. This reaction forms a nylon-6 (made from a cyclic lactam, also known as episilon-aminocaproic acid) that is a linear polyamide. Further, nylon copolymers are also contemplated. Copolymers can be made by combining various diamine compounds, various diacid compounds and various cyclic lactam structures in a reaction mixture and then forming the nylon with randomly positioned monomeric materials in a polyamide structure. For example, a nylon 6,6-6,10 material is a nylon manufactured from hexamethylene diamine and a blend of diacids. A nylon 6-6, 6-6,10 is a nylon manufactured by copolymerization of epsilonaminocaproic acid, hexamethylene diamine and a blend of a C₆ and a C₁₀ diacid material.

Block copolymers are also useful in the process of this invention. With such copolymers the choice of solvent swelling agent is important. The solvent is selected such that both blocks of the copolymer are soluble in the solvent because if one block is not soluble in the solvent, then the copolymer will form a gel.

Additional polymers like polyvinylidene fluoride, syndiotactic polystyrene, copolymer of vinylidene fluoride and hexafluoropropylene, polyvinyl alcohol, polyvinyl acetate, amorphous addition polymers, such as poly(acrylonitrile) and its copolymers with acrylic acid and methacrylates, polystyrene, poly(vinyl chloride) and its various copolymers, poly(methyl methacrylate) and its various copolymers, can be solution spun with relative ease because they are soluble at low pressures and temperatures. However, highly crystalline polymer like polyethylene and polypropylene require high temperature, high pressure solvent if they are to be solution spun. Therefore, solution spinning of the polyethylene and polypropylene is very difficult. Electrostatic solution spinning is one method of making nanofibers and microfiber.

In addition, useful fiber-forming materials that can act as bactericidal fibers include, but are not limited to, cellulose, cellulose esters and ethers, polyethers, polyolefins, polyvinyl halides, polyvinyl esters, polyvinyl ethers, polyvinyl alcohols, polyvinyl sulfates, polyvinyl phosphates, polyvinyl amines, polyamides, polyimides, polyoxidiazoles, polytriazols, polycarbodiimides, polysulfones, polycarbonates, polyethers, polyarylene oxides, polyesters, polyarylates, phenol-formaldehyde resins, melamine-formaldehyde resins, formaldehyde-ureas, ethyl-vinyl acetate copolymers, co-polymers and block interpolymers thereof, and combinations thereof. Variations of the above materials and other useful polymers include the substitution of groups, such as hydroxyl, halogen, lower alkyl groups, lower alkoxy groups, monocyclic aryl groups, and the like.

Further non-limiting examples of fiber-forming polymeric materials include poly(acrylic acid), poly(N-vinylformamide), polyethylene oxide, polyacrylonitrile, poly(meth)acrylamide, poly(hydroxyethyl acrylate), hydroxyethylcellulose, methylcellulose, and mixtures thereof. Other potentially applicable materials include polymers, such as polystyrenes and acrylonitrile-styrene copolymers, styrene-butadiene copolymers, and other non-crystalline or amorphous polymers and structures.

### Biocides

To improve bactericidal properties, the fibers can be modified with antimicrobial additives including chlorhexidine, nitrophenyl acetate, phenylhydrazine, polybrominated salicylanilides, penicillin and synthetic antibiotics, domaphen bromide, cetylpyridinium chloride, benzethonium chloride, 2,2′-thiobisthiobis (4,6-dichloro)phenol, 2,2′-methelenebis(3,4,6′-trichloro)phenol, 2,4,4′-trichloro-2′-hydroxydiphenyl ether, and or other similar anti-microbial agents of which Microban™ is a commercially available example that can be added to the bulk or surface layers of the fibers (see U.S. Pat. No. 4,343,853; hereby incorporated by reference).

In certain embodiments, the antimicrobial agent is selected from the group consisting of water soluble alcohols; water miscible alcohols; phenolic compounds; benzoic acid and its salts; sorbic acid and its salts; metal containing compositions; quaternary ammonium compounds; biguanides; bis-biguanide alkanes; short chain alkyl esters of p-hydroxybenzoic acid, commonly known as parabens; N-(4-chlorophenyl)-N′-(3,4-dichlorophenyl)urea; azoles; chitosan; and derivatives of tetracycline, thienamycin, chloramphenicol, cefoxitin, neomycin, fluoroquinolone, fatty acid salts, sulfonamides, and aminoglycoside that have hydrophilic solvent or water solubility; and combinations of two or more thereof.

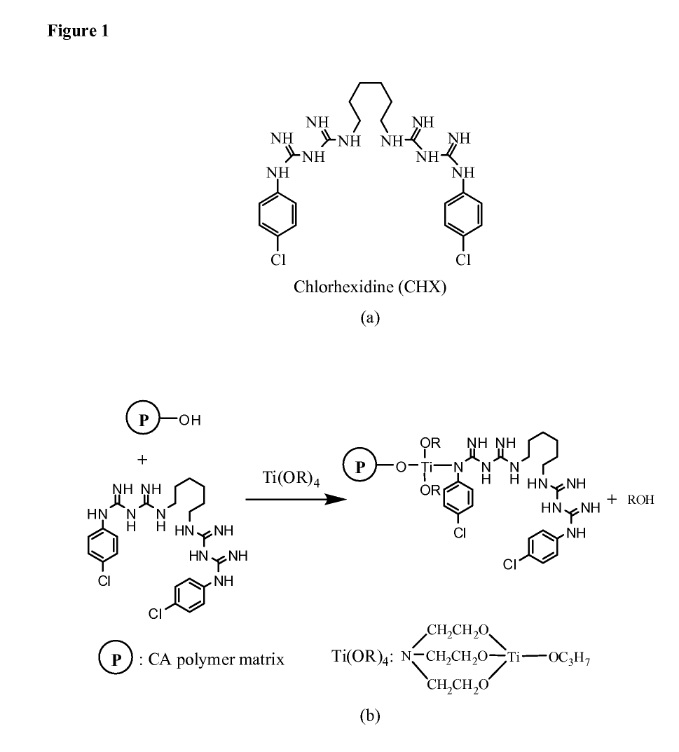

In certain embodiments, the antimicrobial agent is chlorhexidine (CHX). Chlorhexidine (see FIG. 1A) has been widely used as an effective antibacterial agent in applications that range from common disinfectants to bactericidal agents in dentistry; this is largely due to its broad range of antimicrobial activities against bacteria and fungi, high killing rate and nontoxicity towards the mammalian cells [Odore R, Valle V C, Re G. Vet Res Commun 2000; 24:229; and Gjermo P. J Clin Periodontol 1974; 1:143]. The commonly cited mechanism of action of CHX is that two symmetrically positioned chlorophenyl guanide groups can penetrate through the cellular wall of bacteria and irreversibly disrupt the bacterial membrane, thus killing the microorganism. In contrast with certain aspects of the invention described herein, in most materials that include CHX as the biocide, CHX is simply enmeshed within the material and gradually leaches out to kill the bacteria [Riggs P D, Braden M, Patel M. Biomaterials 2000; 21:345; and Yue I C, Poff J, Cortes M E, Sinisterra R D, Faris C B, Hildgen P, Langer R, Shastri V P. Biomaterials 2004; 25:3743]. One disadvantage of such a loose association is that the antibacterial agent is eventually exhausted and the material has a limited functional life.

In certain embodiments, the antimicrobial agent is applied to electrospun fibers (e.g. electrospun fiber mats) by layer-by-layer deposition. The layer-by-layer (LBL) assembly method, discussed in more detail below, is a versatile and cost-effective approach to form thin film coatings via alternative adsorption of positively and negatively charged species from aqueous solutions [Hammond P T, Form and function in multilayer assembly: New applications at the nanoscale, Adv. Mat. 2004, 16, 1271-1293]. As described below, this technique was applied to coat cationic bactericidal polymers onto electrospun poly(acrylonitrile) (PAN) fibers to obtain bactericidal fiber mats. This approach takes advantage of high surface area and porosity of electrospun fibers to improve the antibacterial properties of functional fiber mats.

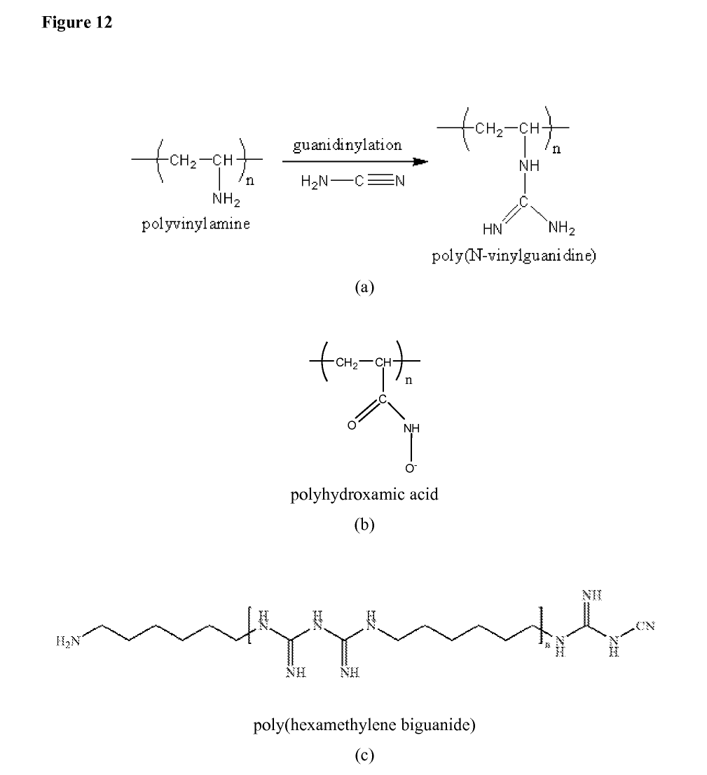

In certain embodiments, the cationic bactericidal polymers are polymeric biguanides. Biguanides, including polymeric biguanides, as a class are known to have antimicrobial activity. Poly(hexamethylene biguanide) also known as PHMB or PAPB has been used as an antimicrobial component in many applications including topical disinfectants and as a preservative in health care products. PHMB is commonly represented by the formula shown in FIG. 12(c), though it is known to exist as a complex mixture of polymeric biguanides with various terminal groups including guanidine. The value n represents the number of repeating units of the biguanide polymer. GB 1434040, hereby incorporated by reference, describes the use of PHMB and several other biguanide structures and their effectiveness as antimicrobial components.

In certain embodiments, the cationic bactericidal polymers are hydrocarbon polymers, with significant hydrophobic character, and they contain at least one amino group with a pKa of greater than or equal to about 8. See U.S. Application Publication No. 2006/0228966, hereby incorporated by reference. This means that, at conditions below a pH of 8, a significant portion of the amino groups will be protonated and cationic. Furthermore, in certain embodiments, the degree of polymer crosslinking can be controlled by adding a difunctional monomer or by increasing the energy input to the process. Crosslinking can increase the durability and adhesion of the coating without effecting the effectiveness. Cross-linking agents include, but are not limited to, 2-ethyl-2(hydroxymethyl)propane-trimethyacrylate (TRIM), acrylic acid, methacrylic acid, trifluoro-methacrylic acid, 2-vinylpyridine, 4-vinylpyridine, 3(5)-vinylpyridine, p-methylbenzoic acid, itaconic acid, 1-vinylimidazole, and mixtures thereof.

Examples of cationic monomers which can be polymerized to form cationic bactericidal polymers include amine and amide monomers, and quaternary amine monomers. Amine and amide monomers include, but are not limited to: dimethylaminoethyl acrylate; diethylaminoethyl acrylate; dimethyl aminoethyl methacrylate; diethylaminoethyl methacrylate; tertiary butylaminoethyl methacrylate; N,N-dimethyl acrylamide; N,N-dimethylaminopropyl acrylamide; acryloyl morpholine; N-isopropyl acrylamide; N,N-diethyl acrylamide; dimethyl aminoethyl vinyl ether; 2-methyl-1-vinyl imidazole; N,N-dimethylaminopropyl methacrylamide; vinyl pyridine; vinyl benzyl amine methyl chloride quarternary; dimethylaminoethyl methacrylate methyl chloride quaternary; diallyldimethylammonium chloride; N,N-dimethylaminopropyl acrylamide methyl chloride quaternary; trimethyl-(vinyloxyethyl) ammonium chloride; 1-vinyl-2,3-dimethylimidazolinium chloride; vinyl benzyl amine hydrochloride; vinyl pyridinium hydrochloride; and mixtures thereof Quaternary amine monomers which may be used in the composition of the invention can include those obtained from the above amine monomers such as by protonation using an acid or via an alkylation reaction using an alkyl halide.

In certain embodiments, the invention relates to the use of biocides which target Gram-negative and/or Gram-positive bacteria. The term ‘Gram-positive bacteria’ is an art recognized term for bacteria characterized by having as part of their cell wall structure peptidoglycan as well as polysaccharides and/or teichoic acids and are characterized by their blue-violet color reaction in the Gram-staining procedure. Representative Gram-positive bacteria include: actinomyces spp., Bacillus anthracis, Bifidobacterium spp., Clostridium botulinum, Clostridium perfringens, Clostridium spp., Clostridium tetani, Corynebacterium diphtheriae, Corynebacterium jeikeium, Enterococcus faecalis, Enterococcus faecium, Erysipelothrix rhusiopathiae, Eubacterium spp., Gardnerella vaginalis, Gemella morbillorum, Leuconostoc spp., Mycobacterium abcessus, Mycobacterium avium complex, Mycobacterium chelonae, Mycobacterium fortuitum, Mycobacterium haemophilium, Mycobacterium kansasii, Mycobacterium leprae, Mycobacterium marinum, Mycobacterium scrofulaceum, Mycobacterium smegmatis, Mycobacterium terrae, Mycobacterium tuberculosis, Mycobacterium ulcerans, Nocardia spp., Peptococcus niger, Peptostreptococcus spp., Proprionibacterium spp., Staphylococcus aureus, Staphylococcus auricularis, Staphylococcus capitis, Staphylococcus cohnii, Staphylococcus epidermidis, Staphylococcus haemolyticus, Staphylococcus hominis, Staphylococcus lugdanensis, Staphylococcus saccharolyticus, Staphylococcus saprophyticus, Staphylococcus schleiferi, Staphylococcus similans, Staphylococcus warneri, Staphylococcus xylosus, Streptococcus agalactiae (group B streptococcus), Streptococcus anginosus, Streptococcus bovis, Streptococcus canis, Streptococcus equi, Streptococcus milleri, Streptococcus mitior, Streptococcus mutans, Streptococcus pneumoniae, Streptococcus pyogenes (group A streptococcus), Streptococcus salivarius, Streptococcus sanguis. The term “Gram-negative bacteria” is an art recognized term for bacteria characterized by the presence of a double membrane surrounding each bacterial cell. Representative Gram-negative bacteria include Acinetobacter calcoaceticus, Actinobacillus actinomycetemcomitans, Aeromonas hydrophile, Alcaligenes xylosoxidans, Bacteroides, Bacteroides fragilis, Bartonella bacilliformis, Bordetella spp., Borrelia burgdorferi, Branhamella catarrhalis, Brucella spp., Campylobacter spp., Chalmydia pneumoniae, Chlamydia psittaci, Chlamydia trachomatis, Chromobacterium violaceum, Citrobacter spp., Eikenella corrodens, Enterobacter aerogenes, Escherichia coli, Flavobacterium meningosepticum, Fusobacterium spp., Haemophilus influenzae, Haemophilus spp., Helicobacter pylori, Klebsiella spp., Legionella spp., Leptospira spp., Moraxella catarrhalis, Morganella morganii, Mycoplasma pneumoniae, Neisseria gonorrhoeae, Neisseria meningitidis, Pasteurella multocida, Plesiomonas shigelloides, Prevotella spp., Proteus spp., Providencia rettgeri, Pseudomonas aeruginosa, Pseudomonas spp., Rickettsia prowazekii, Rickettsia rickettsii, Rochalimaea spp., Salmonella spp., Salmonella typhi, Serratia marcescens, Shigella spp., Treponema carateum, Treponema pallidum, Treponema pallidum endemicum, Treponema pertenue, Veillonella spp., Vibrio cholerae, Vibrio vulnificus, Yersinia enterocolitica, Yersinia pestis.

### Methods of Layer-by-Layer Assembly

An exemplary layer-by-layer deposition techniques involves sequentially dipping a electrospun fiber into a pair of coating solutions. Alternatively, a electrospun fiber may be sprayed with a solution in a spray or mist form. One coating process embodiment involves solely dip-coating and optionally dip-rinsing steps. Another coating process embodiment involves solely spray-coating and optionally spray-rinsing steps. Of course, a number of alternatives involve various combinations of spray- and dip-coating and optionally spray- and dip-rinsing steps may be designed by a person having ordinary skill in the art.

For example, a solely dip-coating process involves the steps of immersing a electrospun fiber in a solution of a charged polymeric material; optionally rinsing the electrospun fiber by immersing the electrospun fiber in a rinsing solution; immersing said electrospun fiber in a solution of an oppositely charge polymeric material; and optionally rinsing said electrospun fiber in a rinsing solution, thereby forming a bilayer of the charged polymeric materials. This bilayer formation process may be repeated a plurality of times in order to produce a thicker layer-by-layer coating.

The immersion time for each of the coating and optional rinsing steps may vary depending on a number of factors. Preferably, immersion of the core material into a coating solution occurs over a period of about 1 to 30 minutes, more preferably about 1 to 20 minutes, and most preferably about 1 to 5 minutes. Rinsing may be accomplished with a plurality of rinsing steps, but a single rinsing step, if desired, can be quite efficient.

Another embodiment of the coating process involves a series of spray coating techniques. The process generally includes the steps of spraying a core material of a electrospun fiber with a solution of a charged polymeric material; optionally rinsing the electrospun fiber by spraying the electrospun fiber with a rinsing solution and then optionally drying the electrospun fiber; spraying the electrospun fiber with a solution of a non-charged polymeric material which can be non-covalently bond to the charged polymeric material on the electrospun fiber; optionally rinsing the electrospun fiber by spraying the electrospun fiber with a rinsing solution, thereby to form a bilayer of the charged polymeric material and the non-charged polymeric material. This bilayer formation procedure may be repeated a plurality of times in order to produce a thicker layer-by-layer coating.

The spray coating application may be accomplished via a process selected from the group consisting of an air-assisted atomization and dispensing process, an ultrasonic-assisted atomization and dispensing process, a piezoelectric assisted atomization and dispensing process, an electromechanical jet printing process, a piezo-electric jet printing process, a piezo-electric with hydrostatic pressure jet printing process, and a thermal jet printing process; and a computer system capable of controlling the positioning of the dispensing head of the spraying device on the ophthalmic lens and dispensing the coating liquid. By using such spraying coating processes, an asymmetrical coating can be applied to a electrospun fiber.

In accordance with the present invention, coating solutions can be prepared in a variety of ways. In particular, a coating solution of the present invention can be formed by dissolving a charged polymeric material in water or any other solvent capable of dissolving the materials. When a solvent is used, any solvent that can allow the components within the solution to remain stable in water is suitable. For example, an alcohol-based solvent can be used. Suitable alcohol can include, but are not limited to, isopropyl alcohol, hexanol, ethanol, etc. It should be understood that other solvents commonly used in the art can also be suitably used in the present invention.

Whether dissolved in water or in a solvent, the concentration of a material (i.e., a charged polymeric material) in a solution of the present invention can generally vary depending on the particular materials being utilized, the desired coating thickness, and a number of other factors.

It may be typical to formulate a relatively dilute aqueous solution of charged polymeric material. For example, a charged polymeric material concentration can be between about 0.0001% to about 0.25% by weight, between about 0.005% to about 0.10% by weight, or between about 0.01% to about 0.05% by weight.

In general, the charged polymeric solutions mentioned above can be prepared by any method well known in the art for preparing solutions. Once dissolved, the pH of the solution can also be adjusted by adding a basic or acidic material. For example, a suitable amount of 1N hydrochloric acid (HC1) can be added to adjust the pH to 2.5.

Where a solid polyelectrolyte comprises at least one bilayer of a first charged polymeric material and a second charged polymeric material having charges opposite of the charges of the first charged polymeric material, it may be desirable to apply a solution containing both the first and second charged polymeric materials within a single solution. For example, a polyanionic solution can be formed as described above, and then mixed with a polycationic solution that is also formed as described above. The solutions can then be mixed slowly to form a coating solution. The amount of each solution applied to the mix depends on the molar charge ratio desired. For example, if a 10:1 (polyanion:polycation) solution is desired, 1 part (by volume) of the polycation solution can be mixed into 10 parts of the polyanion solution. After mixing, the solution can also be filtered if desired.

One aspect of the invention relates to a method of forming a antimicrobial coating on an electrospun fiber, comprising the steps of:

(a) contacting the electrospun fiber with a solution of a first charged polymeric material to form a layer of the charged polymeric material;

(b) optionally rinsing the resulting electrospun fiber by contacting said surface with a rinsing solution;

(c) contacting said the optionally rinsed electrospun fiber with a solution of a second charged polymeric material, to form a layer of the second charged polymeric material on top of the layer of the first charged polymeric material, thereby forming a bilayer; and

(d) optionally rinsing the resulting electrospun fiber by contacting said electrospun fiber with a rinsing solution;

wherein each bilayer comprises a polycationic layer and a polyanionic layer.

In certain embodiments, the present invention relates to any one of the aforementioned methods, wherein at least one of said contacting occurs by immersion the electrospun fiber in a solution.

In certain embodiments, the present invention relates to any one of the aforementioned methods, wherein at least one of said contacting occurs by immersion the electrospun fiber in a solution with a pH of between about 1.5 to about 5.5. In certain embodiments, the present invention relates to any one of the aforementioned methods, wherein at least one of said contacting occurs by immersion the electrospun fiber in a solution with a pH of between about 1.5 and about 2.5. In certain embodiments, the present invention relates to any one of the aforementioned methods, herein at least one of said contacting occurs by immersion the electrospun fiber in a solution with a pH of between about 2.5 and about 3.5. In certain embodiments, the present invention relates to any one of the aforementioned methods, wherein at least one of said contacting occurs by immersion the electrospun fiber in a solution with a pH of between about 3.5 about 4.5. In certain embodiments, the present invention relates to any one of the aforementioned methods, wherein at least one of said contacting occurs by immersion the electrospun fiber in a solution with a pH of between about 4.5 about 5.5.

In certain embodiments, the present invention relates to any one of the aforementioned methods, wherein said method comprises repeating steps (a) through (d) between about 3 times and about 10 times. In certain embodiments, the present invention relates to any one of the aforementioned methods, wherein said method comprises repeating steps (a) through (d) between about 10 times and about 30 times. In certain embodiments, the present invention relates to any one of the aforementioned methods, wherein said method comprises repeating steps (a) through (d) between about 30 times and about 50 times. In certain embodiments, the present invention relates to any one of the aforementioned methods, wherein said method comprises repeating steps (a) through (d) between about 50 times and about 100 times. In certain embodiments, the present invention relates to any one of the aforementioned methods, wherein said method comprises repeating steps (a) through (d) between about 100 times and about 200 times.

In certain embodiments, the present invention relates to any one of the aforementioned methods, wherein about 10% of the polyelectrolyte bilayers are cross-linked. In certain embodiments, the present invention relates to any one of the aforementioned methods, wherein about 30% of the polyelectrolyte bilayers are cross-linked. In certain embodiments, the present invention relates to any one of the aforementioned methods, wherein about 50% of the polyelectrolyte bilayers are cross-linked. In certain embodiments, the present invention relates to any one of the aforementioned methods, wherein about 70% of the polyelectrolyte bilayers are cross-linked. In certain embodiments, the present invention relates to any one of the aforementioned methods, wherein about 90% of the polyelectrolyte bilayers are cross-linked.

In certain embodiments, the present invention relates to any one of the aforementioned methods, wherein the number of bilayers is about 200. In certain embodiments, the present invention relates to any one of the aforementioned methods, wherein the number of bilayers is about 150. In certain embodiments, the present invention relates to any one of the aforementioned methods, wherein the number of bilayers is about 100. In certain embodiments, the present invention relates to any one of the aforementioned methods, wherein the number of bilayers is about 50. In certain embodiments, the present invention relates to any one of the aforementioned methods, wherein the number of bilayers is about 30. In certain embodiments, the present invention relates to any one of the aforementioned methods, wherein the number of bilayers is about 25. In certain embodiments, the present invention relates to any one of the aforementioned methods, wherein the number of bilayers is about 20. In certain embodiments, the present invention relates to any one of the aforementioned methods, wherein the number of bilayers is about 15. In certain embodiments, the present invention relates to any one of the aforementioned methods, wherein the number of bilayers is about 10. In certain embodiments, the present invention relates to any one of the aforementioned methods, wherein the number of bilayers is about 5.

### Other Pharmaceutical Agents

While certain aspects of the invention described herein relate to the incorporation of antimicrobial agents into and onto fibers, it should be understood that other pharmaceutical agents may be used. Pharmaceutical agents which may be used include any therapeutic molecule including, without limitation, any pharmaceutical substance or drug. Examples of pharmaceuticals include, but are not limited to, anesthetics, hypnotics, sedatives and sleep inducers, antipsychotics, antidepressants, antiallergics, antianginals, antiarthritics, antiasthmatics, antidiabetics, antidiarrheal drugs, anticonvulsants, antigout drugs, antihistamines, antipruritics, emetics, antiemetics, antispasmodics, appetite suppressants, neuroactive substances, neurotransmitter agonists, antagonists, receptor blockers and reuptake modulators, beta-adrenergic blockers, calcium channel blockers, disulfiram and disulfiram-like drugs, muscle relaxants, analgesics, antipyretics, stimulants, anticholinesterase agents, parasympathomimetic agents, hormones, anticoagulants, antithrombotics, thrombolytics, immunoglobulins, immunosuppressants, hormone agonists/antagonists, vitamins, antimicrobial agents, antineoplastics, antacids, digestants, laxatives, cathartics, antiseptics, diuretics, disinfectants, fungicides, ectoparasiticides, antiparasitics, heavy metals, heavy metal antagonists, chelating agents, gases and vapors, alkaloids, salts, ions, autacoids, digitalis, cardiac glycosides, antiarrhythmics, antihypertensives, vasodilators, vasoconstrictors, antimuscarinics, ganglionic stimulating agents, ganglionic blocking agents, neuromuscular blocking agents, adrenergic nerve inhibitors, anti-oxidants, vitamins, cosmetics, anti-inflammatories, wound care products, antithrombogenic agents, antitumoral agents, antiangiogenic agents, anesthetics, antigenic agents, wound healing agents, plant extracts, growth factors, emollients, humectants, rejection/anti-rejection drugs, spermicides, conditioners, antibacterial agents, antifungal agents, antiviral agents, antibiotics, tranquilizers, cholesterol-reducing drugs, antitussives, histamine-blocking drugs, monoamine oxidase inhibitor. All substances listed by the U.S. Pharmacopeia are also included within the substances of the present invention.

Further, pharmaceutical agents which are suitable herein can be organic or inorganic and may be in a solid, semisolid, liquid, or gas phase. Molecules may be present in combinations or mixtures with other molecules, and may be in solution, suspension, or any other form. Examples of classes of molecules that may be used include human or veterinary therapeutics, cosmetics, nutraceuticals, agriculturals, such as herbicides, pesticides and fertilizers, vitamins, salts, electrolytes, amino acids, peptides, polypeptides, proteins, carbohydrates, lipids, nucleic acids, glycoproteins, lipoproteins, glycolipids, glycosaminoglycans, proteoglycans, growth factors, hormones, neurotransmitters, pheromones, chalones, prostaglandins, immunoglobulins, monokines and other cytokines, humectants, metals, gases, minerals, plasticizers, ions, electrically and magnetically reactive materials, light sensitive materials, anti-oxidants, molecules that may be metabolized as a source of cellular energy, antigens, and any molecules that can cause a cellular or physiological response. Any combination of molecules can be used, as well as agonists or antagonists of these molecules.

### Cross-Linkers

Cross-linking agents of the present invention are used to covalently bind the polymeric material used to produce the fibers, bind the polymeric material to the bactericidal agent, or both. Such crosslinking agents include, for example, multifunctional aldehydes (e.g., glutaraldehyde), multifunctional acrylates (e.g., butanediol diacrylate), halohydrins (e.g., epichlorohydrin), dihalides (e.g., dibromopropane), disulfonate esters, multifunctional epoxies (e.g., ethylene glycol diglycidyl ether), multifunctional esters (e.g., dimethyl adipate), multifunctional acid halides (e.g., oxalyl chloride), multifunctional carboxylic acids (e.g., succinic acid), carboxylic acid anhydrides (e.g., succinic anhydride), organic titanates (e.g., TYZOR from DuPont), dibromoalkanes, melamine resins (e.g., CYMEL 301, CYMEL 303, CYMEL 370, and CYMEL 373 from Cytec Industries, Wayne, N.J.), hydroxymethyl ureas (e.g., N,N′-dihydroxymethyl-4,5-dihydroxyethyleneurea), multifunctional isocyanates (e.g., toluene diisocyanate or methylene diisocyanate).

Conventionally, the crosslinking agent is water or organic solvent soluble, and possesses sufficient reactivity with the polymeric material of the present invention such that crosslinking occurs in a controlled fashion, preferably at a temperature of about 5° C. to about 150° C. Preferred crosslinking agents are organic titanates and most preferable titanium triethanolamine (Tyzor TE from DuPont).

In certain embodiments, it is preferable that the cross-linker is added only after the fibers are manufactured, so that the polymeric material and bactericide solution do not form a gel prior to the spinning process.

### Bactericidal Action and Applications

Sterilants, sanitizers, disinfectants, sporicides, viracides and tuberculocidal agents provide a lethal, irreversible action resulting in partial or complete microbial cell destruction or incapacitation are referred to as “bactericidal” action.

In certain embodiments, the invention relates to the production of improved antimicrobial fabrics and articles made therefrom, which fabrics and articles do not lose the desirable attributes of comfort, soft hand, absorbency, better appearance which have heretofore been available only by utilization of naturally occurring articles. In other embodiments, the antimicrobial fiber compositions of the invention can be used for a variety of domestic or industrial applications, e.g., to reduce microbial or viral populations on a surface or object or in a stream of water. The fiber compositions can be applied to a variety of hard or soft surfaces having smooth, irregular or porous topography. Suitable soft surfaces include, for example paper; filter media, hospital and surgical linens and garments; soft-surface medical or surgical instruments and devices; and soft-surface packaging. Such soft surfaces can be made from a variety of materials comprising, for example, paper, fiber, woven or nonwoven fabric, soft plastics and elastomers. The fiber compositions of the invention can also be applied to soft surfaces, such as food and skin. Suitable hard surfaces include, for example, architectural surfaces (e.g., floors, walls, windows, sinks, tables, counters and signs); eating utensils; hard-surface medical or surgical instruments and devices; and hard-surface packaging. Such hard surfaces can be made from a variety of materials comprising, for example, ceramic, metal, glass, wood or hard plastic.

The antimicrobial fiber compositions may, for example, be incorporated into a textile or other apparel starting material in the form of a layer (e.g., a liner layer). The obtained raw wearing apparel material may then be used to make a protective garment, glove, sock, footwear (e.g., shoe), helmet, face mask and the like; the obtained wearing apparel nay be worn in hazardous environments to protect the wearer from contact with viable microorganisms. The combination as desired or as necessary may flexible or stiff; depending on the nature of the carrier component and also on the form of the resin (e.g., plate, particle, etc.); the carrier component may comprise a (e.g., flexible) polymeric matrix. The carrier component may comprise a porous cellular matrix; bactericidal fibers may be dispersed in a polymeric matrix

The antimicrobial fiber compositions can also be used on foods and plant species to reduce surface microbial populations; used at manufacturing or processing sites handling such foods and plant species; or used to treat process waters around such sites. For example, the compositions can be used on food transport lines, food storage facilities; anti-spoilage air circulation systems; refrigeration and cooler equipment; beverage chillers and warmers, blanchers, cutting boards, third sink areas, and meat chillers or scalding devices.

The antimicrobial fiber compositions can also be used to reduce microbial and viral counts in air and liquids by incorporation into filtering media or breathing filters, e.g., to remove water and air-born pathogens.

Other hard surface cleaning applications for the antimicrobial compositions of the invention include clean-in-place (CIP) systems, clean-out-of-place (COP) systems, washer-decontaminators, sterilizers, textile laundry machines, ultra and nano-filtration systems and indoor air filters. COP systems can include readily accessible systems including wash tanks, soaking vessels, mop buckets, holding tanks, scrub sinks, vehicle parts washers, non-continuous batch washers and systems, and the like.

The antimicrobial compositions can be applied to microbes or to soiled or cleaned surfaces using a variety of methods. For example, the antimicrobial fiber composition can be wiped onto a surface.

### Selected Embodiments of the Invention

One aspect of the invention relates to an antimicrobial fiber, having a diameter, comprising: an electroprocessed blend of at least one polymer, at least one antimicrobial agent, and at least one crosslinker.

Another aspect of the invention relates to an antimicrobial fiber, having a diameter, comprising: an electroprocessed blend of at least one polymer and at least one crosslinker; and at least one antimicrobial agent.

In certain embodiments, the invention relates to any one of the aforementioned antimicrobial fibers, wherein said electroprocessed blend is an electrospun blend.

In certain embodiments, the invention relates to any one of the aforementioned antimicrobial fibers, wherein said at least one polymer is selected from the group consisting of polyolefins, polyacetals, polyacrylonitrile, polyamides, polyesters, cellulose ethers and estesr, polyalkylene sulfides, polyarylene oxides, polysulfones, modified polysulfone polymers and mixtures thereof.

In certain embodiments, the invention relates to any one of the aforementioned antimicrobial fibers, wherein said at least one polymer is selected from the group consisting of polyethylene, polyacrylonitrile, polypropylene, poly(vinylchloride), polymethylmethacrylate (and other acrylic resins), polystyrene, and copolymers thereof (including ABA type block copolymers), poly(vinylidene fluoride), poly(vinylidene chloride), polyvinylalcohol in various degrees of hydrolysis (87% to 99.5%) in crosslinked and non-crosslinked forms, and mixtures thereof.

In certain embodiments, the invention relates to any one of the aforementioned antimicrobial fibers, wherein said at least one polymer is selected from the group consisting of nylons and copolymers of nylons made by combining various diamine compounds, various diacid compounds and various cyclic lactam structures in a reaction mixture and then forming the nylon with randomly positioned monomeric materials in a polyamide structure, and mixtures thereof.

In certain embodiments, the invention relates to any one of the aforementioned antimicrobial fibers, wherein said at least one polymer is selected from the group consisting of polyvinylidene fluoride, syndiotactic polystyrene, copolymer of vinylidene fluoride, hexafluoropropylene, polyvinyl alcohol, polyvinyl acetate, amorphous addition polymers, such as poly(acrylonitrile) and its copolymers with acrylic acid and methacrylates, polystyrene, poly(vinyl chloride) and its various copolymers, poly(methyl methacrylate) and its various copolymers, and mixtures thereof.

In certain embodiments, the invention relates to any one of the aforementioned antimicrobial fibers, wherein said at least one polymer is selected from the group consisting of cellulose, cellulose esters and ethers, polyethers, polyolefins, polyvinyl halides, polyvinyl esters, polyacrylonitrile, polyvinyl ethers, polyvinyl alcohols, polyvinyl sulfates, polyvinyl phosphates, polyvinyl amines, polyamides, polyimides, polyoxidiazoles, polytriazols, polycarbodiimides, polysulfones, polycarbonates, polyethers, polyarylene oxides, polyesters, polyarylates, phenol-formaldehyde resins, melamine-formaldehyde resins, formaldehyde-ureas, ethyl-vinyl acetate copolymers, co-polymers and block interpolymers thereof, and combinations thereof.

In certain embodiments, the invention relates to any one of the aforementioned antimicrobial fibers, wherein said at least one polymer is selected from the group consisting of poly(acrylic acid), poly(N-vinylformamide), polyethylene oxide, polyacrylonitrile, poly(meth)acrylamide, poly(hydroxyethyl acrylate), hydroxyethylcellulose, methylcellulose, polystyrenes and acrylonitrile-styrene copolymers, styrene-butadiene copolymers, and other non-crystalline or amorphous polymers and structures, and mixtures thereof.

In certain embodiments, the invention relates to any one of the aforementioned antimicrobial fibers, wherein said at least one polymer is cellulose acetate (CA).

In certain embodiments, the invention relates to any one of the aforementioned antimicrobial fibers, wherein said at least one antimicrobial agent is selected from the group consisting of chlorhexidine, nitrophenyl acetate, phenylhydrazine, polybrominated salicylanilides, penicillin and synthetic antibiotics, domaphen bromide, cetylpyridinium chloride, benzethonium chloride, 2,2′-thiobisthiobis(4,6-dichloro)phenol, and 2,2′-methelenebis(3,4,6′-trichloro)phenol, 2,4,4′-trichloro-2′-hydroxydiphenyl ether.

In certain embodiments, the invention relates to any one of the aforementioned antimicrobial fibers, wherein said pharmaceutically-active agent is chlorhexidine (CHX).

In certain embodiments, the invention relates to any one of the aforementioned antimicrobial fibers, wherein said electroprocessed blend further comprises at least one high-molecular-weight polymer.

In certain embodiments, the invention relates to any one of the aforementioned antimicrobial fibers, wherein said at least one high-molecular-weight polymer has a molecular weight of greater than about 1 MDa.

In certain embodiments, the invention relates to any one of the aforementioned antimicrobial fibers, wherein said at least one high-molecular-weight polymer has a molecular weight of about 2 MDa.

In certain embodiments, the invention relates to any one of the aforementioned antimicrobial fibers, wherein said at least one high-molecular-weight polymer has a molecular weight of about 5 MDa.

In certain embodiments, the invention relates to any one of the aforementioned antimicrobial fibers, wherein said at least one high-molecular-weight polymer is polyethylene oxide (PEO).

In certain embodiments, the invention relates to any one of the aforementioned antimicrobial fibers, wherein said at least one crosslinker is selected from the group consisting of multifunctional aldehydes, multifunctional acrylates, halohydrins, dihalides, disulfonate esters, multifunctional epoxies, multifunctional esters, multifunctional acid halides, multifunctional carboxylic acids, carboxylic acid anhydrides, organic titanates, dibromoalkanes, melamine resins, hydroxymethyl ureas, and multifunctional isocyanates.

In certain embodiments, the invention relates to any one of the aforementioned antimicrobial fibers, wherein said at least one crosslinker is selected from the group consisting of glutaraldehyde, butanediol diacrylate, epichlorohydrin, dibromopropane, ethylene glycol diglycidyl ether, dimethyl adipate, oxalyl chloride, succinic acid, succinic anhydride, TYZOR (e.g. titanium acetylacetonates, titanium triethanolamine), CYMEL 301 (hexamethoxymethyl melamine with a low methylol content having alkoxy groups as the principle reactive groups and a degree of polymerization of 1.5), CYMEL 303, CYMEL 370, CYMEL 373, N,N′-dihydroxymethyl-4,5-dihydroxyethyleneurea, toluene diisocyanate, and methylene diisocyanate.

In certain embodiments, the invention relates to any one of the aforementioned antimicrobial fibers, wherein said at least one crosslinker is an organic titanate linker.

In certain embodiments, the invention relates to any one of the aforementioned antimicrobial fibers, wherein said at least one crosslinker is titanium triethanolamine (Tyzor® TE (TTE)).

In certain embodiments, the invention relates to any one of the aforementioned antimicrobial fibers, wherein said diameter is between about 0.1 nanometers and about 100 microns.

In certain embodiments, the invention relates to any one of the aforementioned antimicrobial fibers, wherein said diameter is between about 10 nanometers and about 25 microns.

In certain embodiments, the invention relates to any one of the aforementioned antimicrobial fibers, wherein said diameter is between about 100 nanometers and about 2 microns.

In certain embodiments, the invention relates to any one of the aforementioned antimicrobial fibers, wherein said electrospun blend comprises said polymer and said crosslinker at a ratio of about 3:1 (w/w).

In certain embodiments, the invention relates to any one of the aforementioned antimicrobial fibers, wherein said electrospun blend comprises said polymer and said high-molecular-weight polymer at a ratio of about 15:1 (w/w).

In certain embodiments, the invention relates to any one of the aforementioned antimicrobial fibers, wherein said antimicrobial fiber comprises said polymer and said antimicrobial agent at a ratio of about 10:1 (w/w).

In certain embodiments, the invention relates to any one of the aforementioned antimicrobial fibers, wherein said antimicrobial fiber comprises said polymer and said antimicrobial agent at a ratio of about 5:1 (w/w).

In certain embodiments, the invention relates to any one of the aforementioned antimicrobial fibers, wherein said antimicrobial fiber comprises said polymer and said antimicrobial agent at a ratio of about 10:3 (w/w).

In certain embodiments, the invention relates to any one of the aforementioned antimicrobial fibers, wherein said antimicrobial fiber comprises said polymer and said antimicrobial agent at a ratio of about 5:2 (w/w).

In certain embodiments, the invention relates to any one of the aforementioned antimicrobial fibers, wherein said electrospun blend comprises said polymer and said antimicrobial agent at a ratio of about 10:1 (w/w).

In certain embodiments, the invention relates to any one of the aforementioned antimicrobial fibers, wherein said electrospun blend comprises said polymer and said antimicrobial agent at a ratio of about 5:1 (w/w).

In certain embodiments, the invention relates to any one of the aforementioned antimicrobial fibers, wherein said electrospun blend comprises said polymer and said antimicrobial agent at a ratio of about 10:3 (w/w).

In certain embodiments, the invention relates to any one of the aforementioned antimicrobial fibers, wherein said electrospun blend comprises said polymer and said antimicrobial agent at a ratio of about 5:2 (w/w).

In certain embodiments, the invention relates to any one of the aforementioned antimicrobial fibers, wherein said at least one antimicrobial agent is a cationic polymer.

In certain embodiments, the invention relates to any one of the aforementioned antimicrobial fibers, wherein said cationic polymer comprises biguanide groups.

In certain embodiments, the invention relates to any one of the aforementioned antimicrobial fibers, wherein said cationic polymer comprises polymerized poly(N-vinylguanidine).

In certain embodiments, the invention relates to any one of the aforementioned antimicrobial fibers, wherein said cationic polymer comprises polymerized poly(hexamethylene biguinide).

Another aspect of the invention relates to an antimicrobial fiber mesh comprising a plurality of any one of the aforementioned antimicrobial fibers.

Another aspect of the invention relates to a method of making a antimicrobial fiber, having a diameter, comprising the steps of providing a blend of at least one polymer, at least one cross-linker and at least one organic or aqueous solvent; electroprocessing the blend to form an electroprocessed fiber; and contacting the electroprocessed fiber with at least one antimicrobial agent to form an antimicrobial fiber.

Another aspect of the invention relates to a method of making an antimicrobial fiber, having a diameter, comprising the steps of providing a blend of at least one polymer, at least one antimicrobial agent, at least one cross-linker and at least one organic or aqueous solvent; and electroprocessing the blend to form the antimicrobial fiber.

In certain embodiments, the invention relates to any one of the aforementioned methods, wherein said electroprocessing is electrospinning.

In certain embodiments, the invention relates to any one of the aforementioned methods, wherein said organic or aqueous solvent is selected from the group consisting of water, 2,2,2-trifluoroethanol, 1,1,1,3,3,3-hexafluoro-2-propanol, isopropanol, methanol, ethanol, propanol, halogenated alcohols, acetamide, N-methylformamide, N,N-dimethylformamide (DMF), dimethylsulfoxide (DMSO), dimethylacetamide, N-methyl pyrrolidone (NMP), acetic acid, trifluoroacetic acid, ethyl acetate, acetonitrile, trifluoroacetic anhydride, 1,1,1-trifluoroacetone, maleic acid, and hexafluoroacetone.

In certain embodiments, the invention relates to any one of the aforementioned methods, wherein said organic or aqueous solvent is N,N-dimethylformamide (DMF).

In certain embodiments, the invention relates to any one of the aforementioned methods, wherein said at least one polymer is selected from the group consisting of polyolefins, polyacetals, polyacrylonitrile, polyamides, polyesters, cellulose ethers and estesr, polyalkylene sulfides, polyarylene oxides, polysulfones, modified polysulfone polymers and mixtures thereof.

In certain embodiments, the invention relates to any one of the aforementioned methods, wherein said at least one polymer is selected from the group consisting of polyethylene, polypropylene, polyacrylonitrile, poly(vinylchloride), polymethylmethacrylate (and other acrylic resins), polystyrene, and copolymers thereof (including ABA type block copolymers), poly(vinylidene fluoride), poly(vinylidene chloride), polyvinylalcohol in various degrees of hydrolysis (87% to 99.5%) in crosslinked and non-crosslinked forms, and mixtures thereof.

In certain embodiments, the invention relates to any one of the aforementioned methods, wherein said at least one polymer is selected from the group consisting of nylons and copolymers of nylons made by combining various diamine compounds, various diacid compounds and various cyclic lactam structures in a reaction mixture and then forming the nylon with randomly positioned monomeric materials in a polyamide structure, and mixtures thereof.

In certain embodiments, the invention relates to any one of the aforementioned methods, wherein said at least one polymer is selected from the group consisting of polyvinylidene fluoride, syndiotactic polystyrene, copolymer of vinylidene fluoride, hexafluoropropylene, polyvinyl alcohol, polyvinyl acetate, amorphous addition polymers, such as poly(acrylonitrile) and its copolymers with acrylic acid and methacrylates, polystyrene, poly(vinyl chloride) and its various copolymers, poly(methyl methacrylate) and its various copolymers, and mixtures thereof.

In certain embodiments, the invention relates to any one of the aforementioned methods, wherein said at least one polymer is selected from the group consisting of cellulose, cellulose esters and ethers, polyethers, polyacrylonitrile, polyolefins, polyvinyl halides, polyvinyl esters, polyvinyl ethers, polyvinyl alcohols, polyvinyl sulfates, polyvinyl phosphates, polyvinyl amines, polyamides, polyimides, polyoxidiazoles, polytriazols, polycarbodiimides, polysulfones, polycarbonates, polyethers, polyarylene oxides, polyesters, polyarylates, phenol-formaldehyde resins, melamine-formaldehyde resins, formaldehyde-ureas, ethyl-vinyl acetate copolymers, co-polymers and block interpolymers thereof, and combinations thereof.

In certain embodiments, the invention relates to any one of the aforementioned methods, wherein said at least one polymer is selected from the group consisting of poly(acrylic acid), poly(N-vinylformamide), polyethylene oxide, polyacrylonitrile, poly(meth)acrylamide, poly(hydroxyethyl acrylate), hydroxyethylcellulose, methylcellulose, polystyrenes and acrylonitrile-styrene copolymers, styrene-butadiene copolymers, and other non-crystalline or amorphous polymers and structures, and mixtures thereof.

In certain embodiments, the invention relates to any one of the aforementioned methods, wherein said at least one polymer is cellulose acetate (CA).

In certain embodiments, the invention relates to any one of the aforementioned methods, wherein said at least one antimicrobial agent is selected from the group consisting of chlorhexidine, nitrophenyl acetate, phenylhydrazine, polybrominated salicylanilides, penicillin and synthetic antibiotics, domaphen bromide, cetylpyridinium chloride, benzethonium chloride, 2,2′-thiobisthiobis(4,6-dichloro)phenol, and 2,2′-methelenebis(3,4,6′-trichloro)phenol, 2,4,4′-trichloro-2′-hydroxydiphenyl ether.

In certain embodiments, the invention relates to any one of the aforementioned methods, wherein said pharmaceutically-active agent is chlorhexidine (CHX).

In certain embodiments, the invention relates to any one of the aforementioned methods, wherein said blend further comprises at least one high-molecular-weight polymer.

In certain embodiments, the invention relates to any one of the aforementioned methods, wherein said at least one high-molecular-weight polymer has a molecular weight of greater than about 1 MDa.

In certain embodiments, the invention relates to any one of the aforementioned methods, wherein said at least one high-molecular-weight polymer has a molecular weight of about 2 MDa.

In certain embodiments, the invention relates to any one of the aforementioned methods, wherein said at least one high-molecular-weight polymer has a molecular weight of about 5 MDa.

In certain embodiments, the invention relates to any one of the aforementioned methods, wherein said at least one high-molecular-weight polymer is polyethylene oxide (PEO).

In certain embodiments, the invention relates to any one of the aforementioned methods, wherein said at least one crosslinker is selected from the group consisting of multifunctional aldehydes, multifunctional acrylates, halohydrins, dihalides, disulfonate esters, multifunctional epoxies, multifunctional esters, multifunctional acid halides, multifunctional carboxylic acids, carboxylic acid anhydrides, organic titanates, dibromoalkanes, melamine resins, hydroxymethyl ureas, and multifunctional isocyanates.

In certain embodiments, the invention relates to any one of the aforementioned methods, wherein said at least one crosslinker is selected from the group consisting of glutaraldehyde, butanediol diacrylate, epichlorohydrin, dibromopropane, ethylene glycol diglycidyl ether, dimethyl adipate, oxalyl chloride, succinic acid, succinic anhydride, TYZOR (e.g. titanium acetylacetonates, titanium triethanolamine), CYMEL 301, CYMEL 303, CYMEL 370, CYMEL 373, N,N′-dihydroxymethyl-4,5-dihydroxyethyleneurea, toluene diisocyanate, and methylene diisocyanate.

In certain embodiments, the invention relates to any one of the aforementioned methods, wherein said at least one crosslinker is an organic titanate linker.

In certain embodiments, the invention relates to any one of the aforementioned methods, wherein said at least one crosslinker is titanium triethanolamine (Tyzor® TE (TTE)).

In certain embodiments, the invention relates to any one of the aforementioned methods, wherein said diameter is between about 0.1 nanometers and about 100 microns.

In certain embodiments, the invention relates to any one of the aforementioned methods, wherein said diameter is between about 10 nanometers and about 25 microns.

In certain embodiments, the invention relates to any one of the aforementioned methods, wherein said diameter is between about 100 nanometers and about 2 microns.

In certain embodiments, the invention relates to any one of the aforementioned methods, wherein said blend comprises said polymer and said crosslinker at a ratio of about 3:1 (w/w).

In certain embodiments, the invention relates to any one of the aforementioned methods, wherein said electrospun blend comprises said polymer and said high-molecular-weight polymer at a ratio of about 15:1 (w/w).

In certain embodiments, the invention relates to any one of the aforementioned methods, wherein said antimicrobial fiber comprises said polymer and said antimicrobial agent at a ratio of about 10:1 (w/w).

In certain embodiments, the invention relates to any one of the aforementioned methods, wherein said antimicrobial fiber comprises said polymer and said antimicrobial agent at a ratio of about 5:1 (w/w).

In certain embodiments, the invention relates to any one of the aforementioned methods, wherein said antimicrobial fiber comprises said polymer and said antimicrobial agent at a ratio of about 10:3 (w/w).

In certain embodiments, the invention relates to any one of the aforementioned methods, wherein said antimicrobial fiber comprises said polymer and said antimicrobial agent at a ratio of about 5:2 (w/w).

In certain embodiments, the invention relates to any one of the aforementioned methods, wherein said blend comprises said polymer and said antimicrobial agent at a ratio of about 10:1 (w/w).

In certain embodiments, the invention relates to any one of the aforementioned methods, wherein said blend comprises said polymer and said antimicrobial agent at a ratio of about 5:1 (w/w).

In certain embodiments, the invention relates to any one of the aforementioned methods, wherein said blend comprises said polymer and said antimicrobial agent at a ratio of about 10:3 (w/w).

In certain embodiments, the invention relates to any one of the aforementioned methods, wherein said blend comprises said polymer and said antimicrobial agent at a ratio of about 5:2 (w/w).

In certain embodiments, the invention relates to any one of the aforementioned methods, wherein said at least one antimicrobial agent is a cationic polymer.

In certain embodiments, the invention relates to any one of the aforementioned methods, wherein said cationic polymer comprises biguanide groups.

In certain embodiments, the invention relates to any one of the aforementioned methods, wherein said cationic polymer comprises polymerized poly(N-vinylguanidine).

In certain embodiments, the invention relates to any one of the aforementioned methods, wherein said cationic polymer comprises polymerized poly(hexamethylene biguinide).

Another aspect of the invention relates to an article comprising any one of the aforementioned antimicrobial fibers.

In certain embodiments, the invention relates to any one of the aforementioned articles, wherein said article is a nanocomposite, a scaffold for tissue engineering, a sensor, an article of protective clothing, a filtration membrane, a mageto-responsonsive fiber or a superhydrophobic membrane.

Another aspect of the invention relates to an antimicrobial fiber prepared by a process comprising the steps of providing a blend of at least one polymer, at least one cross-linker and at least one organic or aqueous solvent; electroprocessing the blend to form an electroprocessed fiber; and contacting the electroprocessed fiber with at least one antimicrobial agent to form an antimicrobial fiber.

Another aspect of the invention relates to an antimicrobial fiber prepared by a process comprising the steps of providing a blend of at least one polymer, at least one antimicrobial agent, at least one cross-linker and at least one organic or aqueous solvent; and electroprocessing the blend to form the antimicrobial fiber.

Another aspect of the invention relates to an antimicrobial fiber prepared by a process comprising the steps of providing a blend of at least one polymer, at least one cross-linker and at least one organic or aqueous solvent; electroprocessing the blend to form an electroprocessed fiber; and contacting the electroprocessed fiber with at least one cationic polymer. In certain embodiments, the resulting fiber is then contacted with an anionic or neutral polymer, followed by a cationic polymer, to form a layer-by-layer coating on the elctroprocessed fiber.

### Exemplification

The invention now being generally described, it will be more readily understood by reference to the following, which is included merely for purposes of illustration of certain aspects and embodiments of the present invention, and is not intended to limit the invention.

### Example 1

### CHX-Containing Fiber Meshes

Herein are disclosed bactericidal fiber meshes which were successfully produced by the electrospinning of polymer blends containing chlorhexidine (CHX; see FIG. 1A), a biocide. It has been shown that the addition of a high molecular weight polyethylene oxide (PEO) to cellulose acetate (CA) solutions significantly improves the elasticity of the CA solutions and facilitates the formation of fibers. A dimensionless De number, defined as the ratio of fluid relaxation time to instability growth time, was used to characterize the spinnability of the blends. It was found that uniform fibers were produced in the region of De greater than about 7. The obtained CA-CHX fibers demonstrated bactericidal capability not only through a gradual release of unbound CHX from the fibers but also via contact with CHX bound on the fibers. Antibacterial fiber mats were also obtained by post-spin treatment of CA-PEO fibers to immobilize CHX on the fibers via titanate linkers. The post-treated fibers achieved similar bactericidal efficiency compared to that of the CA-CHX fibers electrospun from the blends, even with a much lower CHX content. It was surmised and shown that a repeated post-spin treatment of the fiber could result in even higher CHX loading on the fiber surface and may further enhance the bactericidal properties of the fibers.

### 1. Materials and Methods

MATERIALS USED. Cellulose acetate (CA) (Mₙ 50 kDa), chlorhexidine (CHX) (98%), poly (ethylene oxide) (PEO) (Mᵥ 2 MDa and 5 MDa), and N,N-dimethylformamide (DMF) were purchased from Sigma-Aldrich Chemical Co. (St. Louis, Mo.) and used as received. Tyzor® TE (TTE) (80 wt % titanium triethanolamine in isopropanol) was kindly supplied by Du Pont de Nemours & Co. (Wilmington, Del.) and used as received. Chlorhexidine digluconate aqueous solution (20% w/v) was purchased from Alfa Aesar Co. (Ward Hill, Mass.) and used as received. Bacteria E. coli and S. epidermidis were purchased from ATCC (Manassas, Va.) and stored at −80° C. prior to use.

POLYMER SOLUTION CHARACTERIZATION AND ELECTROSPINNING. DMF is a good solvent for CHX powders as well as CA and thus was employed as the electrospinning medium in this work. The lack of elasticity of the CA solutions in DMF did not permit the formation of uniform fibers, however, and droplets were formed instead. A recent study by Yu et al. [Yu J H, Fridrikh S V, Rutledge G C. Polymer 2006; 47:4789] demonstrated that the addition of a small amount of high molecular weight PEO into the spin solution can significantly increase the elasticity (extensional viscosity) of a solution and thus facilitate the electrospinning process. Following this approach, relatively small amounts of PEO (Mᵥ 2 or 5 MDa) were incorporated into the spin solutions in order to generate uniform fibers. A series of polymer solutions of 3 wt % CA with various concentrations of PEO in DMF were prepared. A capillary breakup extensional rheometer (CaBER 1) (Thermo Electron Co.) was used to examine the extensional properties of the polymer solutions and relate these to the properties of the resulting fibers, to determine the concentration of PEO in polymer solutions required for the formation of uniform fibers.

CaBER is a filament stretching apparatus, which measures the mid-point diameter, D_{mid}(t), of the thinning filament over time when a fluid filament constrained axially between two coaxial disks is stretched rapidly over a short distance [Anna S L, McKinley G H. J Rheol 2001; 45:115; and Rodd L E, Scott T P, Cooper-White J J, McKinley G H. Appl Rheol 2005; 15:12]. In these measurements, the Hencky strain, ε, and the apparent extensional viscosity, ηₐₚₚ, are related as follows [Anna S L, McKinley G H. J Rheol 2001; 45:115]:

$$\begin{matrix}ɛ = 2 ln ( \frac{{D}_{0}}{{D}_{mid} ( t )} ) & ( 1 ) \\ {η}_{app} = - \frac{σ}{\frac{d {D}_{mid} ( t )}{d t}} & ( 2 )\end{matrix}$$

where D₀ is the initial diameter of the filament before stretching and σ is the surface tension of the fluid. The time evolution of D_{mid}(t) for viscoelastic fluid is governed by a balance between surface tension and elasticity and can be described by the following model [Rodd L E, Scott T P, Cooper-White J J, McKinley G H. Appl Rheol 2005; 15:12]:

$${D}_{mid} ( t ) = {{D}_{1} ( \frac{{D}_{1} G}{4 σ} )}^{1 / 3} {e}^{- t / 3 {λ}_{p}} \qquad ( 3 )$$

where D₁ is the initial midpoint diameter just after stretching, G the elastic modulus, and λₚ the fluid relaxation time, which is the characteristic time scale of viscoelastic stress growth.

A series of polymer solutions of 3 wt % CA, 0.2 wt % PEO (Mᵥ 5 MDa), 1 wt % TTE and various concentrations of CHX (0.3, 0.6, 0.9 and 1.2 wt %) were prepared by adding PEO, CA, chlorhexidine powders and TTE sequentially into DMF. The solutions were heated to 50° C. upon addition of PEO to facilitate the dissolution of the high molecular weight polymer. Then the polymer blends were stirred at room temperature until clear homogeneous solutions were obtained. The CHX-containing fibers produced from these solutions are denoted CA-CHX fibers. Polymer solutions of 3 wt % CA, 0.2 wt % PEO (Mᵥ 5 MDa) and 1 wt % TTE without CHX were also prepared to produce nonfunctional crosslinked CA fibers, which are denoted CA-TTE fibers. In addition, solutions of 3 wt % CA and 0.2 wt % PEO (Mᵥ 5 MDa) were prepared for post-spin treatment to attach CHX on the fiber surface. These fibers are denoted CA-PEO fibers.

An electrospinning apparatus similar to that described previously by Shin et al. [Shin Y M, Hohman M M, Brenner M P, Rutledge G C. Polymer 2001; 42:9955] was used, except that the spun fibers were collected on a rotating drum (3.5 cm in diameter, 20 cm in length) ground electrode instead of a plate collector, where the collected fibers discharged less efficiently and impeded accumulation of the fiber mesh. A syringe pump (Harvard Apparatus PHD 2000) was used to deliver polymer solution via a Teflon feedline to a capillary nozzle. Voltages up to 30 kV, generated by a power supply (Gamma High Voltage Research ES-30P), were applied between the upper plate and the ground drum to provide the driving force for electrospinning The electrical potential, solution flow rate, and distance between the capillary nozzle and the collector were adjusted to 16-19 kV, 0.04 mL/min, and 45 cm, respectively, to obtain a stable jet.

CHX BINDING TO FIBERS. TTE is an organic titanate that has been applied as a cross-linking agent in adhesives, coatings, oil and gas products, and textiles [DuPont™ Tyzor® Organic Titanates General Brochure; and Kramer J, Prud'homme R K, Wiltzius P. J Colloid Interface Sci 1987; 118:294]. It cross-links or binds compounds with hydroxyl, amino, amido, carboxyl and thio groups [Menon N, Blum F D, Dharani L R. J Appl Polym Sci 1994; 54:113; Morris C E, Welch C M. Textile Res J 1983;53:143; DuPont™ Tyzor® Organic Titanates General Brochure; and Kramer J, Prud'homme R K, Wiltzius P. J Colloid Interface Sci 1987; 118:294]. The cross-linking and titanate polymerization to form titania is activated at high temperature (100-250° C.) and/or in the presence of water [DuPont™ Tyzor® Organic Titanates General Brochure]. Control experiments were conducted to test the binding capability of TTE to CHX. The CHX powder and TTE solution were mixed at a weight ratio of 1:8 to form a yellowish homogeneous suspension. The suspension gradually became clear upon addition of a small amount of water due to the reaction of TTE with CHX, which facilitates the dissolution of CHX. Heating the solution to 70° C. accelerated the reaction process. The viscosity increased dramatically and the solution gradually became pink and pasty or gel-like in appearance, which is indicative of binding of TTE to CHX (FIG. 1B).

In analogous experiments where binding between CHX and the CA polymer matrix via TTE linkers in the fiber meshes was desired, the fibers were placed in an environment of saturated water vapor at 70° C. for 4 days. The fibers turned slightly pink during the curing process, indicating the occurrence of a chemical reaction. A schematic of the binding chemistry (FIG. 1B) depicts the reaction of the organic titanate TTE with the hydroxyl groups of CA and amino groups of CHX, respectively, via transesterification reactions, to covalently bind CHX to the CA polymer matrix.

QUANTIFICATION OF CHX CONTENT IN FIBERS. Not all of the CHX molecules were covalently bound to the polymer matrix during the curing experiments. To determine the fraction of CHX that was not bound to the fibers, weighed fibers (10 mg) were placed in a sufficient quantity of water (100-200 mL) to ensure essentially complete release of free CHX. The unbound CHX that was gradually released upon immersion of the mesh in water was measured using a Hewlett Packard 8453 UV-Vis spectrophotometer by monitoring a characteristic peak at 254 nm and using calibration (absorbance vs. CHX concentration) curves.

FIBER CHARACTERIZATION. The fibers were examined by scanning electron microscopy (SEM) using a JEOL-6060 microscope (JEOL Ltd) to visualize their morphology. A thin layer of gold (ca. 10 nm) was sputter-coated onto the fiber samples.

Prior to FTIR, Raman and XPS measurements, the crosslinked CA-CHX fiber meshes were placed in excess water for 12 hours to completely remove unbound CHX and dried under vacuum at room temperature to constant weight. The complete removal of the CHX not covalently linked to the fiber was ensured by monitoring the CHX concentration in the wash-outs. When no further removal of the CHX from the fibers into water was detected, the fibers were considered to be fully depleted of the unbound CHX.

FTIR spectra were measured in absorbance mode using a Nexus 870 spectrophotometer (Thermo Nicolet Co.) equipped with an ATR accessory. Two hundred and fifty-six scans were accumulated with a resolution of 4 cm⁻¹.

Raman spectra were measured with a Kaiser Hololab 5000R Raman spectrometer (Kaiser Optical Systems Inc.) with an excitation wavelength of 785 nm.

XPS measurements were carried out with a Kratos Axis Ultra Imaging X-ray photoelectron spectrometer (Kratos Analytical Co.) equipped with a monochromatized Al Kα X-ray source.

POST-SPIN TREATMENT OF FIBERS. Bactericidal, CHX-containing CA-CHX fibers were also produced by post-spin treatment of CA-PEO fiber meshes. CA-PEO Fibers were first electrospun from 3 wt % CA and 0.2 wt % PEO (Mᵥ 5 MDa) solutions in DMF. The CA-PEO fiber meshes thus formed were immersed for 1 hour in 10 wt % titanium triethanolamine solution in isopropanol, which was obtained by dilution of the TTE solutions supplied by the manufacturer. The fiber meshes were cured at 110° C. for 10 minutes to bind TTE to CA. The fibers were then rinsed with water several times and dried. The resulting fibers were placed in 5% (w/v) chlorhexidine digluconate aqueous solution for 1 hour and cured in the oven at 90° C. for 30 minutes to immobilize the CHX via the titanate linkers. The treated fibers were rinsed with water several times and dried under vacuum to constant weight. The applied temperatures were used as in Morris et al. [Morris C E, Welch C M. Textile Res J 1983; 53:143], where organic titanates were successfully used to bind antibiotics onto cotton fabrics.

ANTIBACTERIAL TESTS: DISK DIFFUSION TEST. The release-killing capacity of unbound CHX in the CA-CHX fibers was determined by the disk diffusion test method. E. coli and S. epidermidis were cultured by adding 10 μL of the bacteria to 5 mL Luria-Bertani (LB) broth and incubating it under shaking at 37° C. overnight, followed by dilution with a phosphate buffer solution (PBS, pH 7.0) to approximately 5×10⁶/mL. The bacteria were spread onto LB agar plates with cotton swabs. The round slide disks (diameter=22 mm), to which the CA-CHX fibers were attached, were placed on top of the agar plates. The agar plates were inverted and incubated at 37° C. for 16-20 hours. Duplicate experiments were conducted and the zone of inhibition (ZoI) was measured.

ANTIBACTERIAL TESTS: aSTM E2149-01 METHOD. The CA-CHX fiber meshes were placed in excess water for 12 hours to remove unbound CHX molecules, and dried under vacuum to constant weight. The contact-killing capacity of CA-CHX fibers was assayed according to a modified ASTM E2149-01 method (dynamic shake flask test) [ASTM E2149-01 standard test method for determining the antimicrobial activity of immobilized antimicrobial agents under dynamic contact conditions, American Society for Testing and Materials, West Conshohocken, Pa.]. Briefly, E. coli and S. epidermidis were cultured overnight and diluted in PBS to approximately 10⁶/mL. The fiber meshes (100 mg) were placed in a 50 mL bacterial suspension in a sterile flask and the suspension was shaken at 200 rpm at room temperature for 1 hour using an orbital shaker. A certain amount of the suspension (100 μL) was retrieved from the flask before and after exposure to the mesh and plated with serial dilutions. After incubation of agar plates at 37° C. for 16-20 hours, the number of viable colonies was counted visually and the reduction in the number of viable bacteria colonies was calculated after averaging the duplicate counts.

### 2. Results and Discussion

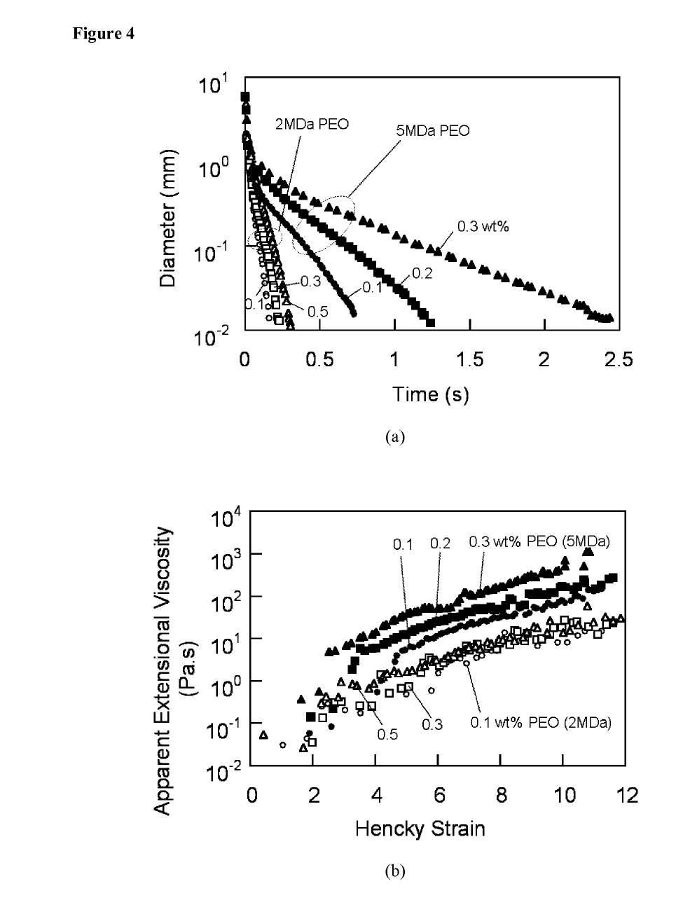

OPTIMIZATION OF CA-PEO ELECTROSPINNING PROCESS. FIG. 4(a) shows the time evolution of the midpoint diameter during the CaBER measurements for six CA-PEO polymer solutions consisting of 3 wt % CA with various concentrations of PEO (Mᵥ 2 and 5 MDa) ranging from 0.1 to 0.5 wt %. The filament breakup time increased with increasing PEO concentration, and was significantly higher for the higher (5 MDa) than for the lower molecular weight (2 MDa) PEO. The curves of apparent extensional viscosity vs. Hencky strain for these six solutions were derived from the time evolution data of midpoint diameter using eqns (1) and (2) and are shown in FIG. 4(b). A clear tendency toward extensional strain hardening was observed for these polymer solutions. The apparent extensional viscosity increased with the PEO concentration and molecular weight. A more elastic solution possesses a slower thinning rate and a longer breakup time due to the resistance to the capillary breakup during extensional deformation afforded by the elastic force. This accounts for the observed increase in the filament breakup time as PEO concentration and molecular weight were increased.

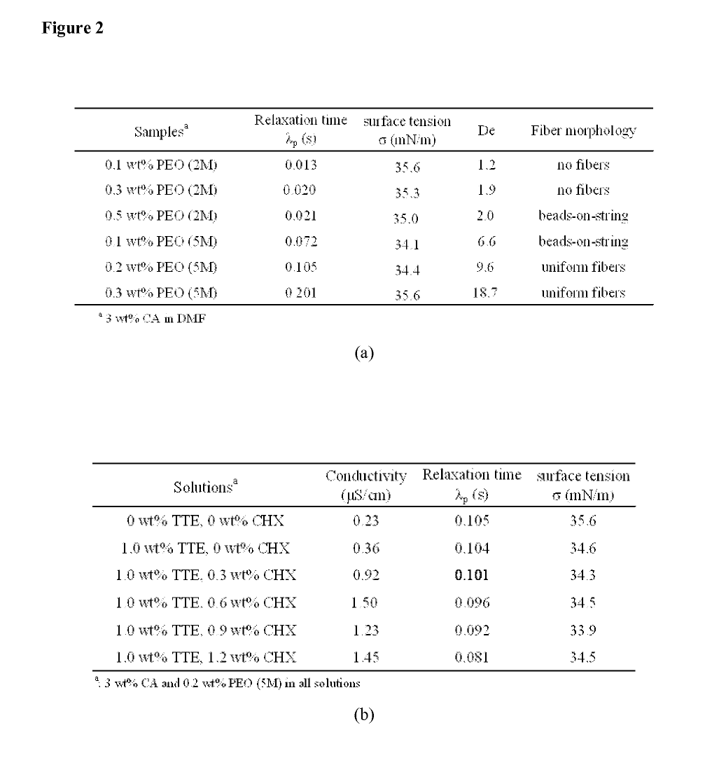

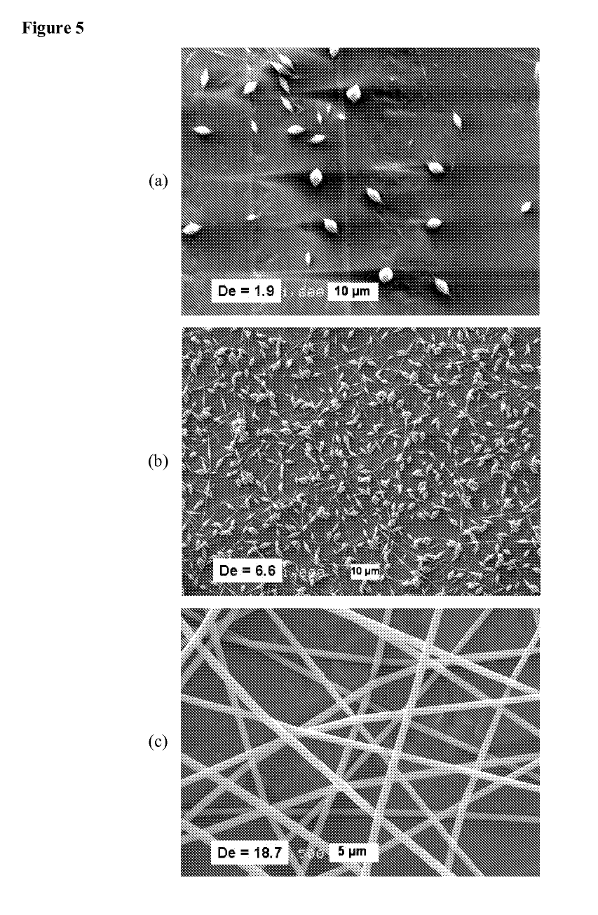

FIG. 5 shows the typical morphologies of the CA-PEO fibers electrospun from the above solutions. The lack of elasticity of the solutions with lower molecular weight and/or lower concentration of PEO leads to the formation of droplets (FIG. 2(a)). A transition in fiber morphology from a beads-on-string structure to a uniform fiber is observed with increasing PEO concentration and molecular weight (FIGS. 2(b) and 2(c)). Uniform fibers are generated when the concentration of PEO (Mᵥ 5 MDa) is at least 0.2 wt % at 3 wt % CA in DMF. The relaxation times, λₚ, were obtained by fitting the elastic model described in eqn (3) to the time evolution data of midpoint diameter in the range of exponential thinning A dimensionless Deborah number, De, was introduced to examine the spinnability of the CA-PEO solutions. De is defined as the ratio of the fluid relaxation time, λₚ, to the Rayleigh instability growth time, t_{R}, as follows [L E, Scott T P, Cooper-White J J, McKinley G H. Appl Rheol 2005; 15:12; and Eggers J. Rev Mod Phys 1997; 69:865]:

$$\begin{matrix}De = \frac{{λ}_{p}}{{t}_{R}} \\ where & ( 4 ) \\ {t}_{R} = \frac{1}{{ω}_{max}} = \sqrt{\frac{ρ {R}_{0}^{3}}{σ} \cdot \frac{{I}_{0} ( {x}_{R} )}{{I}_{1} ( {x}_{R} ) ( 1 - {x}_{R}^{2} ) {x}_{R}}} & ( 5 )\end{matrix}$$

in which ωₘₐₓ is the largest instability growth rate, σ the surface tension, ρ the density, R₀ the initial radius of the polymer jet (0.8 mm in this work), x_{R} the reduced wave number, and I(x_{R}) the modified Bessel function. Prior studies [Goldin M, Yerushalmi J, Pfeffer R, Shinnar R. J Fluid Mech 1969; 38:689; and Chang H-C, Demekhin E A, Kalaidin E. Phys Fluids 1999; 11:1717] have shown that viscoelasticity does not significantly affect the classical Rayleigh wavelength and only slightly increases the growth rate. Therefore, the classical Rayleigh instability growth rate for Newtonian fluids was used to estimate the instability growth time as shown in eqn (5). The most unstable mode, corresponding to ωₘₐₓ occurs at x_{R}=0.697. If the fluid relaxation time is much greater than the instability growth time (De>>1), the instability is fully suppressed or arrested by the viscoelastic response to produce uniform fibers. FIG. 2A shows the relaxation times, De numbers and fiber morphology for all six tested CA-PEO solutions. Only for De>7 were uniform electrospun fibers produced, which is in accordance with the results on electrospun PEO/PEG fibers reported by Yu et al [Yu J H, Fridrikh S V, Rutledge G C. Polymer 2006; 47:4789]. Therefore, De is a good indicator of the spinnability of CA-PEO solutions. The addition of a small amount of high molecular weight PEO can increase the elasticity of polymer solutions and substantially facilitate the electrospinning of CA fibers.

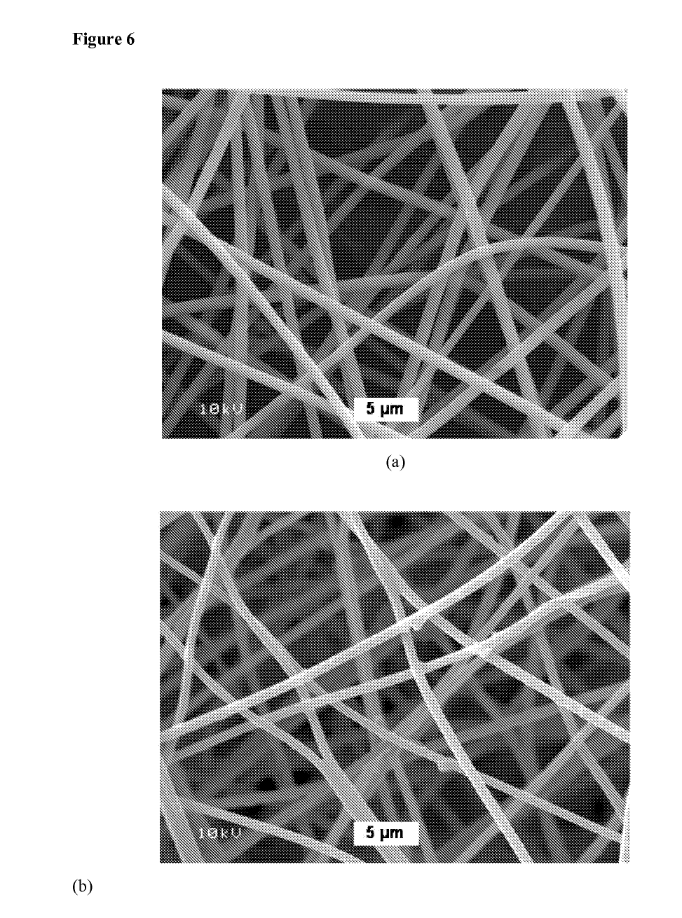

BACTERICIDAL CA-CHX FIBERS ELECTROSPUN FROM POLYMER BLENDS. A series of solutions with 3 wt % CA, 0.2 wt % PEO, 1.0 wt % TTE and various concentrations of CHX (0.3, 0.6, 0.9 and 1.2 wt %) in DMF were electrospun successfully into fibers. The addition of CHX and coupling agent TTE did not impair the electrospinning process, and even facilitated it. The time evolution curves by CaBER measurements for these CHX-containing polymer solutions showed very similar or slightly smaller relaxation times compared to those of the CA-PEO solution without CHX and TTE (FIG. 2B). However, the conductivity of polymer solutions was observed to increase upon the addition of TTE and CHX (FIG. 2B), which is known to stabilize the electrospinning process [Hohman M M, Shin M, Rutledge G, Brenner M P. Phys Fluids 2001; 13:2201; and Hohman M M, Shin M, Rutledge G, Brenner M P. Phys Fluids 2001; 13:2221]. FIG. 6(a) illustrates the typical morphology of electrospun CA-CHX fibers. There was no obvious change in fiber size as the concentration of CHX in the solutions was varied. The average size of these fibers was about 950 nm in diameter with the fiber sizes ranging from 700 to 1200 nm. A typical SEM image of fibers after curing is shown in FIG. 6(b). While the fiber size was not affected by the treatment, some fibers appeared to be coupled together at the junctions, and titanium clusters were observed to form on the surfaces of some fibers. The resultant CA-CHX fibers did not dissolve in THF, which indicated cross-linking of the fiber meshes by the organic titanate, while CA-PEO fibers produced without titanate dissolved in THF readily.

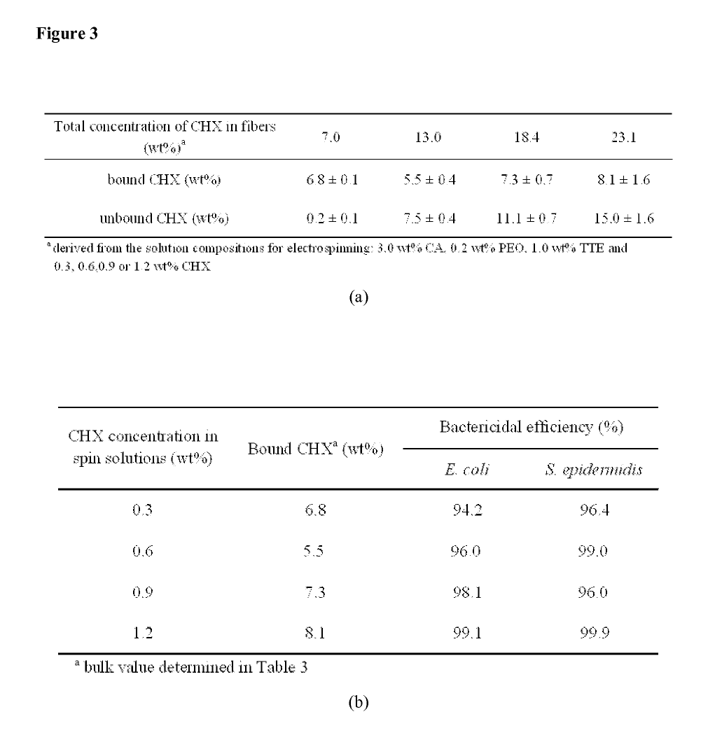

FIG. 3A shows the extent of CHX binding in the fibers determined by the UV-Vis measurements. As is seen, not all of the CHX was bound to the CA polymer matrix during the curing experiments. In the case of 7.0 wt % total CHX content in the fibers, almost all CHX was coupled to the polymer matrix via TTE linkers. As the concentration of CHX in the fibers was increased while the amount of TTE was kept constant (1 wt % in spin solutions), the amount of unbound CHX increased dramatically. However, the concentration of bound CHX varied in a narrow range between 5 to 9 wt %. Furthermore, TTE concentration was increased from 1 to 2 wt % while CHX concentrations were the same as before, to study the effect of TTE concentration on CHX binding. Interestingly, the resulting fibers possess a similar concentration of bound CHX to that of the fibers electrospun from 1 wt % TTE solutions. This indicates that both CHX and TTE concentrations have a weak effect on the extent of CHX binding in these fibers. The concentration of bound CHX varied in a narrow range in these fibers, while the concentration of unbound CHX could be manipulated by controlling the concentration of CHX in the solutions.

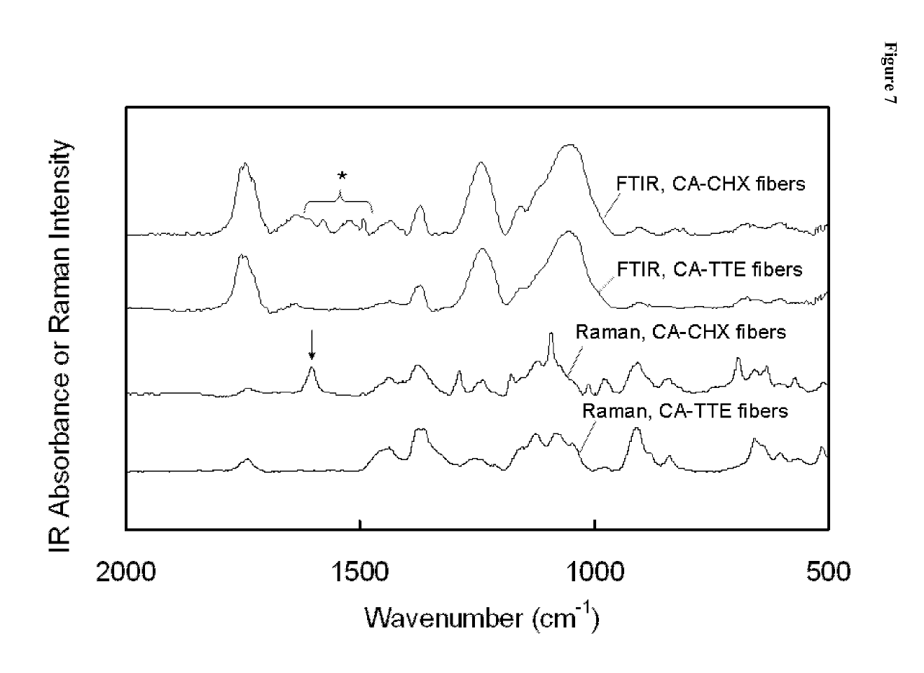

The CA-CHX fibers were characterized by FTIR and Raman spectroscopy. FTIR and Raman spectra of fully washed CA-CHX fibers and crosslinked nonfunctional CA-TTE fibers are shown in FIG. 7.

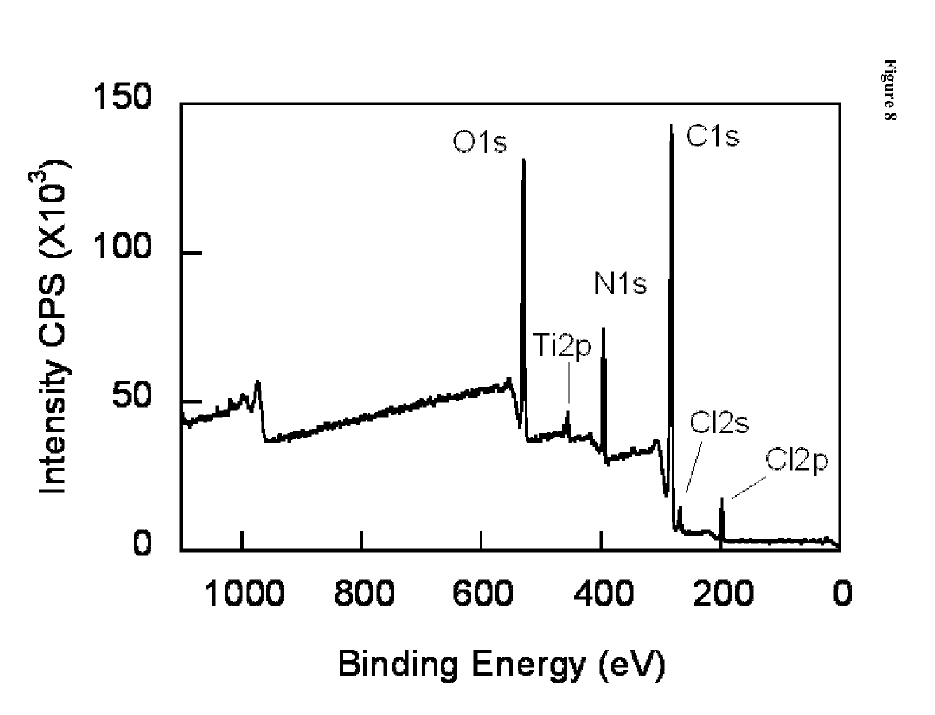

The characteristic IR peaks of CHX observed between 1500 and 1650 cm⁻¹ (C═N stretching and aromatic C═C bending vibrations, respectively) marked by a star (*) indicate the presence of CHX bound to the CA of the fibers. The same characteristic peaks were observed in the ATR-FTIR spectrum of CA-CHX fibers as well, indicating the presence of CHX on the fiber surface. Note the absence of these peaks for the CA-TTE fibers, which contain no CHX. In the Raman spectrum of the CA-CHX fibers, the characteristic CHX peak at 1610 cm⁻¹, as indicated by an arrow in FIG. 7, was observed. The peak is shifted 40 cm⁻¹ to higher wavenumbers compared to that of pure CHX powders (1570 cm⁻¹), which could be attributed to the interaction of CHX with the polymer matrix in the fibers [Jones D S, Brown A F, Woolfson D, Dennis A C, Matchett L J, Bell S E J. J Pharm Sci 2000; 89:563]. XPS was used to determine the surface composition of CA-CHX fibers; a typical XPS spectrum of fully washed CA-CHX fibers is shown in FIG. 8.

The presence of titanium coupling agents on the surface layer was verified by the characteristic binding energy of Ti at 455 eV. The appearance of characteristic binding energies of N and Cl in the spectrum confirmed the presence of CHX bound within 10 nm of the surface of the fibers. The atomic ratio of Cl to C on the surface obtained from XPS measurements increased from 0.02 to 0.05, while the atomic ratio of Cl to O increased from 0.07 to 0.30, as the concentration of CHX in the spin solutions was increased from 0.3 to 1.2 wt %. Both atomic ratios on the surface layer of these fibers were much greater than their bulk values (Cl/C: 0.01-0.02, C1/0: 0.01-0.03) obtained by elemental analysis; this is indicative of enrichment of CHX on the surface of the fibers rather than in the core. CHX has been reported to be a surface-active compound and to form small aggregates in aqueous solution [Sarmiento F, del Rio J M, Prieto G, Attwood D, Jones M N, Mosquera V. J Phys Chem 1995; 99:17628]. Such surface-active properties may promote the accumulation of CHX close to or on the surface of the jet during the electrospinning process.

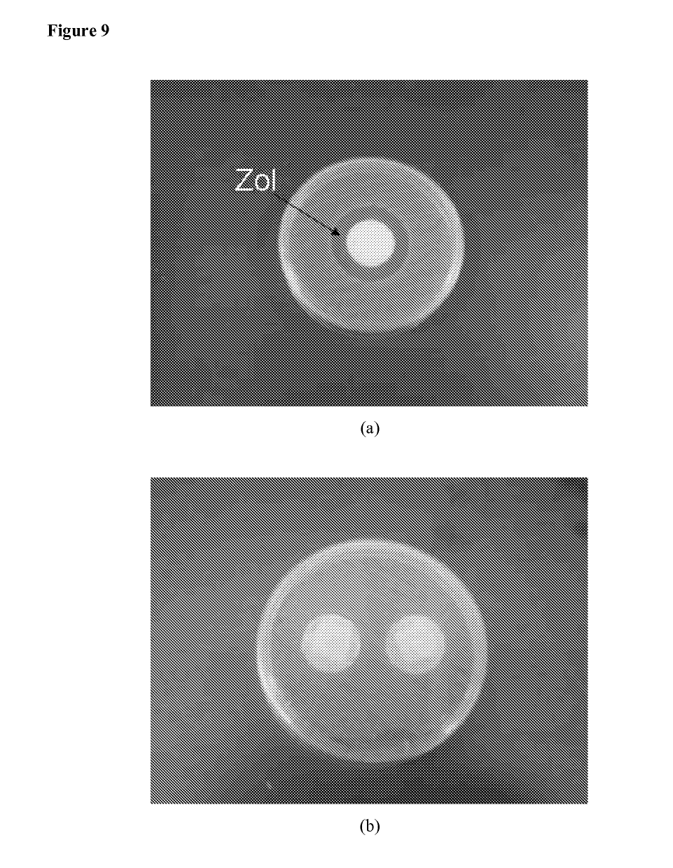

The release-killing capacity of unbound CHX in the fibers was evaluated by disk diffusion tests. The zone of inhibition (ZoI) was observed in all of the tested fiber samples, as indicated by the arrow shown in FIG. 9(a). In this test, unbound CHX in the fibers diffused out of the fibers, killing the bacteria nearby until the minimum inhibitory concentration of CHX (2-8 μg/mL for E. coli and 0.5-2 μg/mL for S. epidermidis [Buxbaum

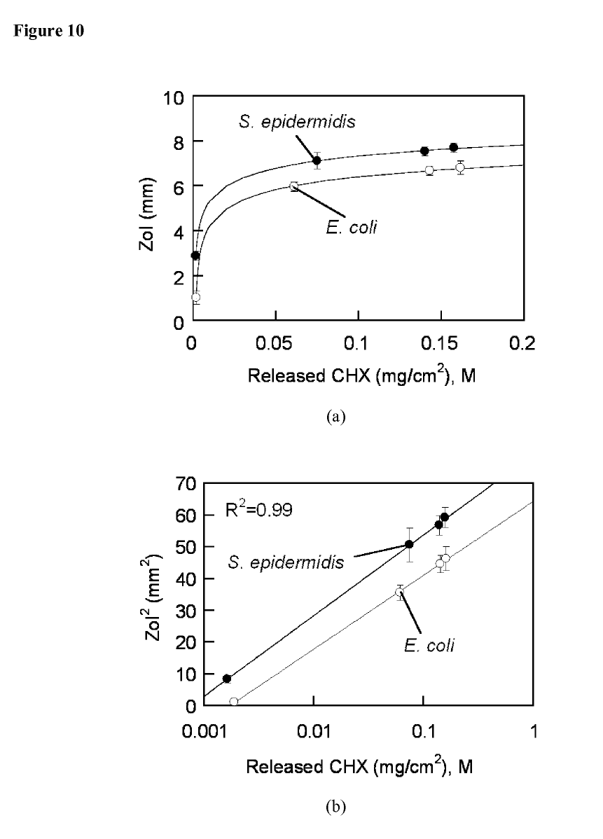

A, Kratzer C, Graninger W, Georgopoulos A. J Antimicrob Chemother 2006; 58:193]) was reached, below which bacteria can survive and proliferate. This resulted in the formation of a circular zone area where no bacterial colonies were observed. The size of the ZoI was measured from the edge of the circular fiber sample (22 mm in diameter) to the edge of the inhibition zone. FIG. 10(a) shows the ZoI determined by the disk diffusion tests against E. coli and S. epidermidis for four different fibers electrospun from four different CHX concentrations. Each datum point represents one type of fiber sample. The amount of CHX released per unit area was calculated from the weight of the circular fiber sample with a diameter of 22 mm (3-5 mg) and the concentration of unbound CHX in the fibers listed in FIG. 3A. The curve shapes of ZoI vs amount of CHX released per unit area (M) are very similar for E. coli and S. epidermidis. The ZoI increased significantly between zero and 0.05 mg/cm² of CHX released, and then increased more gradually for amounts of the released CHX in excess of 0.05 mg/cm². Since this test method is based on the diffusion of unbound CHX, a simple one-dimensional diffusion model can describe the dependence of ZoI on the amount of released CHX from the fibers. That is, assuming radial diffusion of CHX the following relationship between M and ZoI can be derived [Cooper K E. Analytical Microbiology; Academic Press: New York, 1963; Vol. 1, Chapter 1; and Lee D, Cohen R E, Rubner M F. Langmuir 2005; 21:9651]:

$${( ZoI )}^{2} = 4 Dt ( ln ( \frac{M}{{M}^{′}} ) + ln C ) \qquad ( 6 )$$

where M′ is the critical inhibition amount of CHX released per unit area, below which bacteria can survive, D is the diffusion coefficient of CHX under the test conditions, t is the critical time for the formation of inhibition zone (less than the incubation time), and C is a constant. Therefore, ln(M) should be linearly proportional to (ZoI)². The (ZoI)² versus ln(M) dependencies were linear (R²>0.99) for both E. coli and S. epidermidis, as shown in FIG. 10(b).

The contact-killing capacity of CHX bound to the fibers was tested via a modified ASTM E2149-01 procedure. FIG. 9(b) shows a typical photo image of the disk diffusion test results for these fully washed fibers. The absence of the ZoI confirmed the complete removal of free CHX. In the control experiment, the CA-TTE fibers without CHX were tested and did not show any killing of E. coli or S. epidermidis. FIG. 3B shows contact-killing bactericidal activity of the CHX fibers.

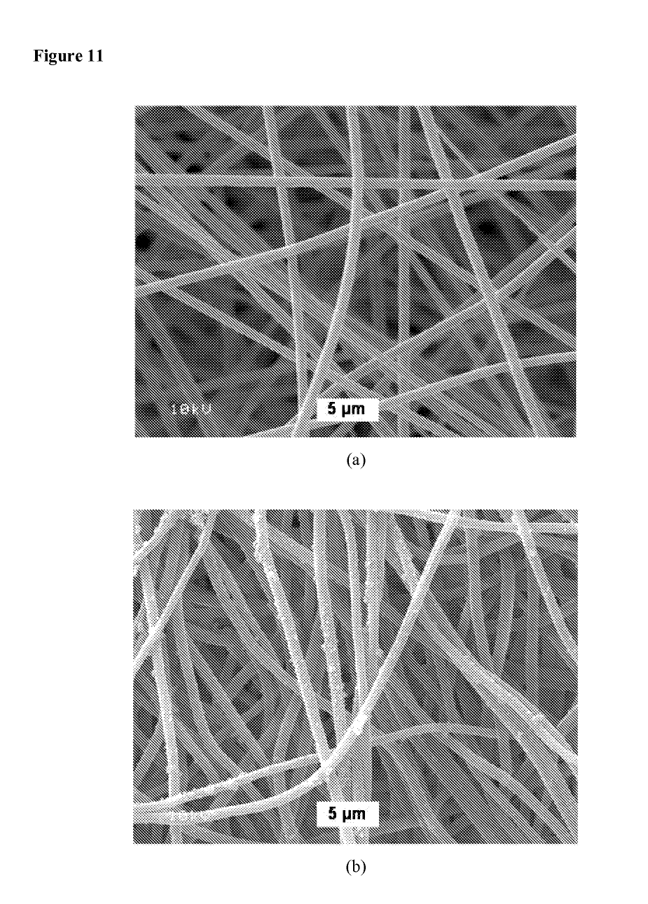

Since all four series of the tested fibers possessed a similar content of bound CHX, the fibers demonstrated similar contact-killing efficiencies, ranging from 94.2% to 99.9%. The XPS measurements indicate a trend towards increasing surface concentration of bound CHX with increasing CHX concentration in the spin solution, which could explain the slight increase in bactericidal efficiency (FIG. 3B). Although the immobilization of CHX on or in the fibers may affect the CHX structure and the surrounding environment, results indicate that the CHX bound on the CA fibers is still capable of killing the bacteria with as high as 3 log reduction or 99.9% bactericidal efficiency of the viable bacteria in 1 hour. For comparison, identical fibers with the unbound CHX not washed out were tested using the modified ASTM E2149-01 procedure. The fibers with a total CHX content of 7.0 wt % exhibited a bactericidal efficiency similar to that of washed fibers with the same overall CHX content, because almost all of the CHX in the unwashed fibers was bound. However, the other three series of fibers with almost equal contents of the bound CHX ranging from 5 to 9 wt % and yet significant contents of unbound CHX (FIG. 3A) showed more than 6 log reduction of viable bacteria due to the release of unbound CHX. Hence, the release of the unbound CHX in the fiber proximity seemed to lead to higher fiber efficiency. POST-SPIN TREATMENT OF CA-PEO FIBERS. In addition to producing CHX-containing CA-CHX fibers via electrospinning of the blends of CA and CHX, a post-spin treatment process to prepare bactericidal fiber meshes was invesitgated. The post-spin treatment allowed us to attach the CHX onto the CA-PEO fibers via titanate linkers. The nonfunctional CA-PEO fiber meshes were immersed in diluted TTE solution and chlorhexidine digluconate solution, respectively, with each step followed by a curing process in the oven to covalently bind CHX onto the fibers. FIG. 11 shows SEM images of as-spun CA-PEO as well as post-spin treated fibers. The size of CA-PEO fibers is 920±120 nm, which is similar to that of CA-CHX fibers electrospun from the blends (FIG. 6(a)). The fiber size was not affected by the post-spin treatment process (FIG. 11(b)), but formation of the titania clusters (ca. 150 nm in diameter) on the post-spin treated fibers was clearly discernible. The fiber meshes remained intact after the post-treatment while the porosity of the fiber mats may have changed during the treatment, as evidenced by a slight but visually observable shrinkage of the fiber meshes. Appearance of the characteristic peaks of CHX located at 1500-1650 cm⁻¹ in ATR-FTIR spectra of the post-treated fibers confirmed the presence of CHX bound on the fibers after washing. Elementary analysis indicated that the amount of CHX attached onto the post-spin treated fibers was approximately 1-2 wt % of the total fiber weight. The antibacterial tests by the modified ASTM E2149-01 method showed that post-treated fibers (100 mg) were effective against E. coli with 99.6% reduction and S. epidermidis with 95.0% reduction of viable bacteria in 1 hour. Compared with the results of the contact-killing tests of the CA-CHX fibers electrospun from polymer blends (FIG. 3B), the post-spin treated fibers can achieve a similar antibacterial capacity with a much lower concentration of CHX attached to the fibers. It follows that repeated post-spin treatment of the fibers will increase the fiber loading for the bactericide, which will further enhance the bactericidal efficiency of the fibers.

### Example 2

### Bactericidal Fibers Using LBL Assembly Method

Herein are disclosed bactericidal fiber meshes which were successfully produced by coating electrospun fibers with biocidal polymers.

### 1. Bactericidal Polymers Containing Biguanide Groups

It is well known that cationic polymers with biguanide groups exhibited higher antimicrobial activities than corresponding low molecular weight compounds [Tashiro T, Antibacterial and Bacterium Adsorbing Macromolecules, Macromol. Mater. Eng. 2001, 286, 63-87]. The effect of polycations with their large charge densities has been attributed to their excellent capacity to bind onto negatively charged cell surfaces and subsequently disrupt the membrane. Poly(N-vinylguanidine) (PVG) is one of the simplest guanidine-bearing polyelectrolytes with pKa of 13.4. FIG. 12(a) describes the modification process of polyvinylamine to poly(N-vinylguanidine). However, it is not limited to PVG. Other cationic polymers with biguanide groups such as poly(hexamethylene biguinide) can also be layer-by-layer coated onto the electrospun fibers.

Since layer-by-layer assembly involves alternative adsorption of cationic and anionic polymers, a broad range of anionic polyelectrolytes such as sulfonated polystyrene can be used to facilitate the process. Specifically, the polyanion we used is polyhydroxamic acid (PHA) with pKₐ of 7.5. FIG. 12(b) shows chemical structure of PHA.

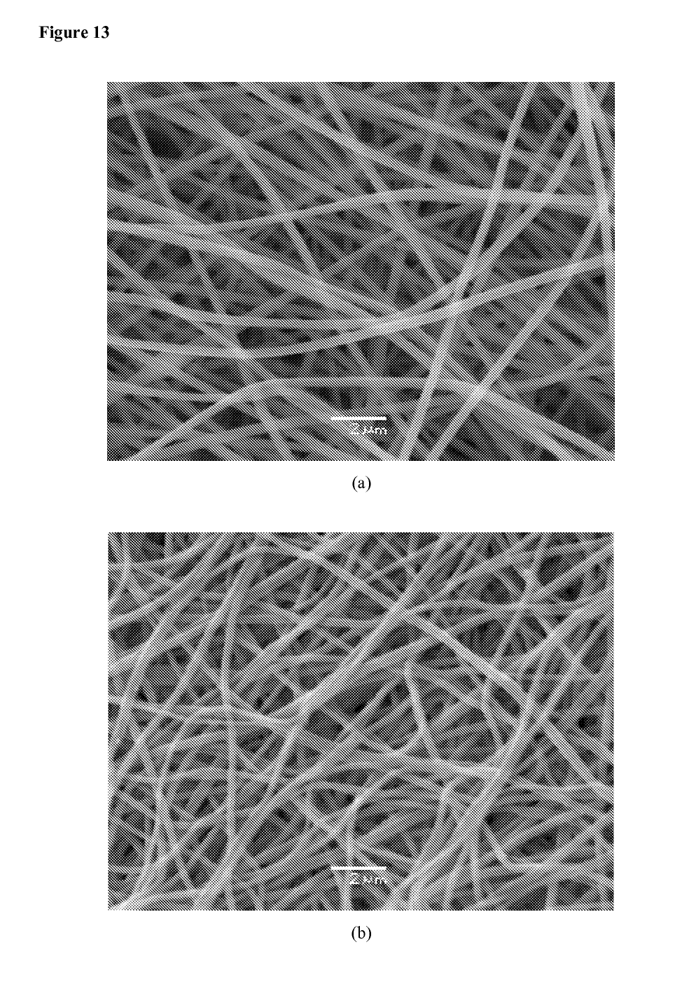

In typical experiments, PAN solutions in DMF (10 wt %) were prepared and electrospun into fiber mats. The PAN fiber mat was first treated in plasma for one minute. Then PVG/PHA multilayers were coated onto the PAN fiber mat in a layer-by-layer automated assembly of alternate dipping into cationic PVG/anionic PHA solutions. The concentration of both polymer solutions was 10 mM with pH maintained constant at 9. Twenty bilayers of PVG/PHA were coated onto the fiber mat. FIG. 13 shows the typical SEM images of prefabricated and coated PAN fiber mats. No significant change in fiber morphology was observed after coating.

### 2. Antibacterial Tests

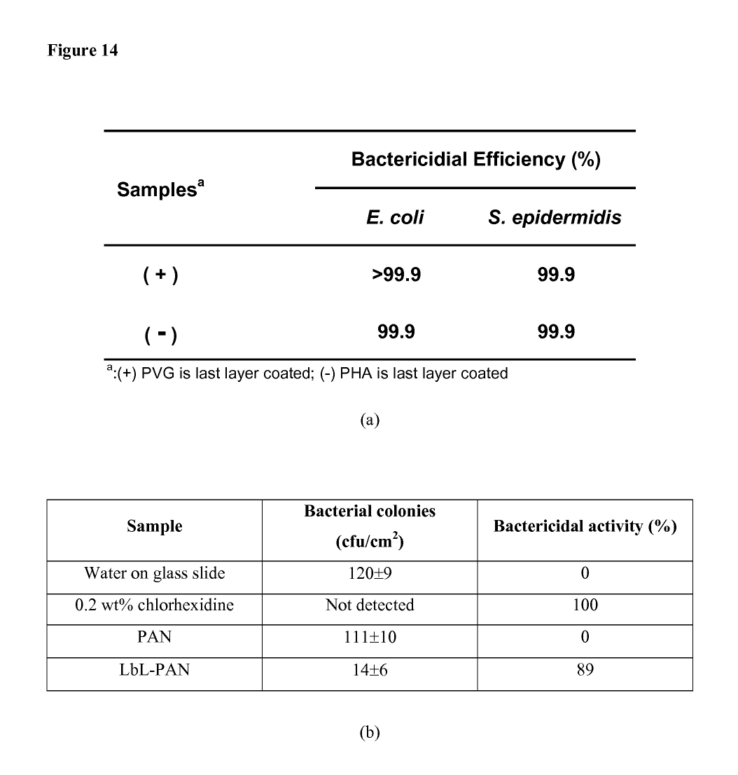

TEST ONE. The bactericidal properties of the PVG/PHA-coated fiber mats were tested against the Gram negative strain Escherichia coli (E. coli.) and the Gram positive strain Staphylococcus epidermidis (S. epidermidis). A modified procedure of the method reported by Tiller et al. was carried out [Tiller J C, Liao C-J, Lewis K, Klibanov M, Design surfaces that kill bacteria on contact, PNAS 2001, 98, 5981-5985.] Briefly, S. epidermidis and E. coli. were cultured overnight and diluted in phosphate buffer solution (PBS) to approximately 10⁴/ml. A bacteria suspension then was sprayed onto a PVG/PHA-coated fiber mat and an uncoated fiber mat in a fume hood by using a commercial chromatography sprayer. After drying for several minutes, the fiber mats were placed on top of the agar plates. The plates were inverted and incubated at 37° C. for 16-20 h. Then the number of viable colonies was counted manually and the reduction in viable bacteria was calculated by comparing the result of coated fibers to that of uncoated control fibers. FIG. 14(a) shows the result of antibacterial tests of the electrospun PAN fiber mats coated with twenty bilayers of PVG/PHA. The PVG/PHA-coated fiber mats exhibited good antibacterial property with killing efficiency of 99.9% against both E. coli and S. epidermidis. Whether PVG is the last layer coated or not almost has no effect on the bactericidal properties of PVG/PHA-coated fiber mats. Although PVG forms electrostatic complex with PHA on the fiber surfaces, it is still effective against the bacteria on contact.

TEST TWO. Two types of PAN nanofibers were tested: modified with twenty bilayers of PVG and PHA (designated LbL-PAN) and the parent PAN fiber species that was not modified (termed PAN) Inhibition of the growth of Staphylococcus aureus (ATCC strain 25923) by the fibers was studied as follows. To prepare the inoculum, freshly grown microorganisms were prepared to a 0.5 McFarland standard (approximately 1.3×10⁸ cfu/ml) and then diluted in Standard Nutrient Broth No. 1 (Sigma-Alrdich).

Each type of nanofibers (5 mg) were initially dispersed in deionized water (1 mL, pH 7). The resulting suspensions were placed on the bottom of 3.2-mL wells of 24-well Corning® Costar® cell culture plates (Sigma-Aldrich Chemical Co.). Three or four wells were used for each fiber species, and 0.2 wt % (final concentration) of chlorhexidine gluconate was used as a positive control, while deionized water without any fibers was used as a negative control. Two mL of the bacterial suspension in broth were placed into corresponding wells (final bacterial concentration, about 1.5 cfu/mL) and each well was vigorously stirred for 2-3 s using sterile pipette tips. The plates were shaken for 10 min at 200 rpm using a KS10 orbital shaker (BEA-Enprotech Corp.) in an environmental chamber at 37° C. Samples of bacterial suspension were removed from the plate well by simple pipetting, which ensured separation of the fiber pieces from the bacteria. The pipetted liquid was sprayed onto a glass slide in a fume hood. Microscope glass slides derivatized with aminopropyltrimethoxy-silane were used. The glass slide was dried by a flow of air for several minutes, placed in a Petri dish, and immediately covered by a layer of MRSA Chromogen Agar (Sigma-Aldrich). The Petri dish was sealed and incubated at 37° C. for 16 h. The grown microbial colonies were then counted. The colonies appeared as bluish-green dots in the agar. The results were expressed in percent of bacterial count on a treated glass slide relative to that on the untreated glass slide [Lin J, Qui S, Lewis K, Klibanov A M, Bactericidal properties of flat surfaces and nanoparticles derivatized with alkylated polyethyleneimines, Biotechnol. Prog. 2002, 18, 1082-1086] and were collected in FIG. 14(b).

### INCORPORATION BY REFERENCE

All of the U.S. patents and U.S. patent application publications cited herein are hereby incorporated by reference.

### Equivalents

Those skilled in the art will recognize, or be able to ascertain using no more than routine experimentation, many equivalents to the specific embodiments of the invention described herein. Such equivalents are intended to be encompassed by the following claims.

1. An antimicrobial fiber, having a diameter, comprising:
an electroprocessed blend of at least one polymer, at least one antimicrobial agent, and at least one crosslinker.

2. An antimicrobial fiber, having a diameter, comprising:
an electroprocessed blend of at least one polymer and at least one crosslinker; and
at least one antimicrobial agent.

3. The antimicrobial fiber of claim 1, wherein said electroprocessed blend is an electrospun blend.

4. The antimicrobial fiber of claim 1, wherein said at least one polymer is selected from the group consisting of polyolefins, polyacrylonitrile, polyacetals, polyamides, polyesters, cellulose ethers and estesr, polyalkylene sulfides, polyarylene oxides, polysulfones, modified polysulfone polymers and mixtures thereof.

5-7. (canceled)

8. The antimicrobial fiber of claim 1, wherein said at least one polymer is selected from the group consisting of cellulose, cellulose esters and ethers, polyethers, polyolefins, polyacrylonitrile, polyvinyl halides, polyvinyl esters, polyvinyl ethers, polyvinyl alcohols, polyvinyl sulfates, polyvinyl phosphates, polyvinyl amines, polyamides, polyimides, polyoxidiazoles, polytriazols, polycarbodiimides, polysulfones, polycarbonates, polyethers, polyarylene oxides, polyesters, polyarylates, phenol-formaldehyde resins, melamine-formaldehyde resins, formaldehyde-ureas, ethyl-vinyl acetate copolymers, co-polymers and block interpolymers thereof, and combinations thereof.

9. (canceled)

10. The antimicrobial fiber of claim 1, wherein said at least one polymer is cellulose acetate (CA).

11. The antimicrobial fiber of claim 1, wherein said at least one antimicrobial agent is selected from the group consisting of chlorhexidine, nitrophenyl acetate, phenylhydrazine, polybrominated salicylanilides, penicillin and synthetic antibiotics, domaphen bromide, cetylpyridinium chloride, benzethonium chloride, 2,2′-thiobisthiobis(4,6-dichloro)phenol, and 2,2′-methelenebis(3,4,6′-trichloro)phenol, 2,4,4′-trichloro-2′-hydroxydiphenyl ether.

12. The antimicrobial fiber of claim 1, wherein said pharmaceutically-active agent is chlorhexidine (CHX).

13. The antimicrobial fiber of claim 1, wherein said electroprocessed blend further comprises at least one high-molecular-weight polymer.

14-16. (canceled)

17. The antimicrobial fiber of claim 13, wherein said at least one high-molecular-weight polymer is polyethylene oxide (PEO).

18. The antimicrobial fiber of claim 1, wherein said at least one crosslinker is selected from the group consisting of multifunctional aldehydes, multifunctional acrylates, halohydrins, dihalides, disulfonate esters, multifunctional epoxies, multifunctional esters, multifunctional acid halides, multifunctional carboxylic acids, carboxylic acid anhydrides, organic titanates, dibromoalkanes, melamine resins, hydroxymethyl ureas, and multifunctional isocyanates.

19. (canceled)

20. The antimicrobial fiber of claim 1, wherein said at least one crosslinker is an organic titanate linker

21. The antimicrobial fiber of claim 1, wherein said at least one crosslinker is titanium triethanolamine.

22. The antimicrobial fiber of claim 1, wherein said diameter is between about 0.1 nanometers and about 100 microns.

23-24. (canceled)

25. The antimicrobial fiber of claim 1, wherein said electrospun blend comprises said polymer and said crosslinker at a ratio of about 3:1 (w/w).

26. The antimicrobial fiber of claim 1, wherein said electrospun blend comprises said polymer and said high-molecular-weight polymer at a ratio of about 15:1 (w/w).

27. The antimicrobial fiber of claim 1, wherein said antimicrobial fiber comprises said polymer and said antimicrobial agent at a ratio of about 10:1 (w/w), about 5:1 (w/w), about 10:3 (w/w) or about 5:2 (w/w).

28-30. (canceled)

31. The antimicrobial fiber of claim 2, wherein said at least one antimicrobial agent is a cationic polymer.

32. The antimicrobial fiber of claim 31, wherein said cationic polymer comprises biguanide groups.

33. The antimicrobial fiber of claim 31, wherein said cationic polymer comprises polymerized poly(N-vinylguanidine) or polymerized poly(hexamethylene biguinide).

34-35. (canceled)

36. A method of making a antimicrobial fiber, having a diameter, wherein the method comprises the steps of providing a blend of at least one polymer, at least one cross-linker and at least one organic or aqueous solvent;
electroprocessing the blend to form an electroprocessed fiber; and contacting the electroprocessed fiber with at least one antimicrobial agent to form an antimicrobial fiber; or
wherein the method comprises the steps of providing a blend of at least one polymer, at least one antimicrobial agent, at least one cross-linker and at least one organic or aqueous solvent; and electroprocessing the blend to form the antimicrobial fiber.

37-76. (canceled)
